(19) United States
(12) Patent Application Publication
(10) Pub. No.: US 2016/0063114 A1
(43) Pub. Date: Mar. 3, 2016

(54) CONTENT ACQUISITION, PROTECTION, AND CONVERSION SYSTEM

(71) Applicant: WavSTAR, LLC, Plainview, NY (US)

(72) Inventors: Renato Marino, Las Vegas, NV (US); Frank Matassa, Plainview, NY (US)

(73) Assignee: WavSTAR, LLC, Plainview, NY (US)

(21) Appl. No.: 14/470,315

(22) Filed: Aug. 27, 2014

(51) Int. Cl. G06F 17/30; H04H 60/07; H04H 60/06

(52) U.S. Cl. CPC G06F 17/30867; H04H 60/06; H04H 60/07; G06F 17/30755

(57) ABSTRACT

The technologies presented herein relate to a computing system, executing instructions comprising components including: a memory component, the memory component configured to store a third party content and a first media content; and a content selection component. The content selection component is configured to retrieve the third party content from the memory component; retrieve the first media content from the memory component; generate a first broadcast, wherein the broadcast generation includes combining the third party content with the first media content; and forward the first broadcast to a first broadcast station. Systems and methods are also disclosed for providing protection to an author against unauthorized usage of collaborative and reviewed works of authorship. Systems and methods are also disclosed for facilitating access to broadcast stations for authors of media stored in computer memory.

### FIELD

This application relates to a system and method for generating and converting digital media from various sources and converting it to desired formats, in particular for transmittal over radio waves.

### BACKGROUND

Conventionally, a radio station, or other media outlet, would have an in-house department and/or group of individuals responsible for generating content, such as commercials, which could be played on the radio station. The in-house department could include such individuals as a producer(s), a copywriter(s), a musician(s), a voice actor(s) (e.g., on air talent). A salesperson representing the radio station would interact with a client requiring an on-air content, such as an advertisement or announcement (also referred to as an ‘ad’ or a ‘spot’), whereby the client's requirements for the content would be established.

Based upon the client's requirements, the in-house department can generate content for the client. The client can review and select the advertisement(s) from the one more advertisements generated by the in-house department, whereupon, the advertisement(s) is subsequently played by the radio-station as part of their programming schedule, also known as ‘airtime.’ Personnel from the radio station would then load the advertising media using their own specific format into the radio station's particular system for timing and playing media over the air.

However, owing to the changing landscape of the various media outlets, e.g., radio, television, newspapers, billboards, the finances and resources available for advertisements has diminished, and accordingly, the in-house resources available to a radio-station have correspondingly reduced. Hence, it is now common for a radio disc jockey (DJ) or radio talk-show host to provide advertising capability for the radio station, e.g., by merely reading copy, accompanied by a jingle. Alternatively, a pre-recorded message having minimal content is selected to be played by the radio DJ/host, or an individual (e.g., content director or producer) at the radio station. If outside content is generated for such use, such as a jingle to be played with the prose script, mixing and converting the format of the outside content to match the station's system requirements must also be addressed. As such, the quality and variety of on-air content has suffered as the demands on the dwindling staff at a radio station have increased.

Some broadcast stations have issues with a lack of programming content to fill all their time slots. Digital content exists from other sources, such as the Internet, but there is not a computerized, efficient, and streamlined process for a station to acquire such content, reformat it, and broadcast it. Similarly, it is difficult for content authors to get their content to a broadcast station.

With the advent of the Internet and digital content storage, unauthorized usage of works of authorship has exploded. It is difficult for an author of content to provide their work in an electronic format, especially over the Internet, and maintain an ability to track who is accessing and potentially copying it.

### SUMMARY

The following is a brief summary of subject matter that is described in greater detail herein. This summary is not intended to be limiting as to the scope of the claims.

The various embodiments presented herein relate to a computer system, e.g., a server, which is configured to receive a job request from a client, a radio-station, a media outlet, or other entity requiring production of a particular content. In an embodiment, the content can be an advertisement. The job request can include one or more requirements regarding the desired advertisement. Further, the computer system can be configured to make the one or more requirements available to a talent pool of individuals. The computer system can be operated by a radio station or other entity involved in the generation and/or broadcasting of advertisements. Further, the individuals can be freelancers, and hence are not directly employed by the radio station, and can generate a work submission(s) based upon their interest in the one or more requirements of the job request. In general operation, the one or more individuals in the talent pool can receive a credit amount, or other payment form, if their submission is selected for use in the advertisement of the client. In another aspect, if a particular individual is generating submissions and/or content that are deemed to have a high value for any of a client or operator of the centralized system, then the individual can be paid a ‘retainer’ credit amount to increase the likelihood that the individual may be available to receive future job requests.

The various embodiments presented herein can eliminate a need for full-time, in-house staff to be employed by a radio station and/or a media outlet by enabling accessibility to a job request on a specification and/or spot-for-hire basis by the one or more freelance individuals. In an aspect, by offering a client's request for advertising to a network of individuals (e.g., more individuals than would likely be employed in an in-house production department in a radio-station) then there is a possibility that the quality of submissions available to a client would be higher than from a single in-house production department.

The client can establish and/or enter the one or more requirements on a first local computing device, wherein the first local computing device can be in communication with the computer system (e.g., operating as a centralized computer system) via a first communication network. Similarly, the one or more individuals in the talent pool can obtain information regarding the one or more requirements via a respective locally located second computing device, wherein the second local computing device can be in communication with the computer system via a second communication network.

The individuals in the talent pool can have one or many skills relating to content of an advertisement and its production. For example, the individuals can have skillsets which include any of copywriting, musician, voice, production, etc.

The one or more requirements can include a wealth of conditions and/or information pertaining to the advertisement. The one or more requirements can include information that similarly pertains to a conventional system, such as what is the message to be delivered in the advertisement?, what product and/or service is to be the subject of the advertisement?, what is the demographic for focus of the advertisement?, a time-length for the advertisement, whether the advertisement is to be voice-only, whether the advertisement is to also include music (e.g., a jingle), whether a single advertisement is to be generated or a plurality of advertisements, etc. The one or more requirements can also include a credit amount being offered by the client for each item in the advertisement, e.g., how much credit is available for generating the copy, how much is available for generating a musical score, how much credit is available for generating a voice over, how much credit is available to produce the advertisement, etc. Accordingly, if an individual's submission is selected for incorporation in or use as the advertisement, then the individual will receive the credit assigned to that particular submission.

In an embodiment, one or more individuals can collaborate on generating content for an advertisement, wherein, upon selection of the collaborative content, the one or more individuals can share a credit amount assigned to generation of the content.

In another embodiment, content can be received from a third party, whereby the computing system can be configured to insert advertising content into the third party content. Thus, a pre-recorded show (e.g., a DJ-hosted show, a talk show, etc.) can have an advertisement inserted therein, whereby the pre-recorded show can be generated for state or national distribution, while the advertisement may be directed towards a more local region, e.g., a town within the state, a town within the nation, a state within the nation, etc.

In another embodiment, a client can indicate how many submissions are to be received for reviewed. A client can establish a limit of submissions they wish to review, such that they are not overwhelmed by an overabundance of submissions.

In another embodiment, one or more submissions, received from one or more individuals, can be analyzed to ensure that they are of a correct format, whereby the correct format can be in accordance with a system utilized by a radio station to broadcast radio content.

In another embodiment, a computing system, executing instructions comprising components includes: a memory component, the memory component configured to store a third party content and a first media content; and a content selection component. The content selection component is configured to retrieve the third party content from the memory component; retrieve the first media content from the memory component; generate a first broadcast, wherein the broadcast generation includes combining the third party content with the first media content; and forward the first broadcast to a first broadcast station.

In another embodiment, systems and methods are also disclosed for providing protection to an author against unauthorized usage of collaborative and reviewed works of authorship.

In another embodiment, systems and methods are also disclosed for facilitating access to broadcast stations for authors of media stored in computer memory and vice-versa.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

FIG. 1 is a block diagram illustrating an exemplary advertisement generation system.

FIG. 2 is a flow diagram illustrating an exemplary methodology for creation of an advertisement by one or more individuals in a talent pool.

FIG. 3 is a flow diagram illustrating an exemplary methodology for establishing and paying a credit for a submission.

FIG. 4 is a flow diagram illustrating an exemplary methodology for formatting a submission.

FIG. 5 is a flow diagram illustrating an exemplary methodology for controlling a number of submissions that can be received.

FIG. 6 is a flow diagram illustrating an exemplary methodology for identifying and making client content available.

FIG. 7 is a flow diagram illustrating an exemplary methodology for securing content in a submission.

FIG. 8 is a flow diagram illustrating an exemplary methodology for incorporating advertising content into a third party content.

FIG. 9 is a flow diagram illustrating an exemplary methodology for generating a profile for an individual in a talent pool.

FIG. 10 is a flow diagram illustrating an exemplary methodology for collaborative generation of advertising content.

FIG. 11 is a block diagram illustrating an exemplary content generation system.

FIG. 12 is a flow diagram illustrating an exemplary methodology for uploading an advertisement to an automation system for broadcasting.

FIG. 13 presents an exemplary user profile screen.

FIG. 14 presents an exemplary job origination screen.

FIG. 15 presents an exemplary job request screen.

FIG. 16 presents an exemplary information review screen.

FIG. 17 presents an exemplary confirmation screen.

FIG. 18 presents an exemplary job overview screen.

FIG. 19 presents an exemplary content submission screen.

FIG. 20 presents an exemplary submission successful screen.

FIG. 21 presents an exemplary submission review screen.

FIG. 22 presents an exemplary submission rating screen.

FIG. 23 presents an exemplary submission selection screen.

FIG. 24 presents an exemplary initiate production screen.

FIG. 25 presents an exemplary credit amount and exchange screen.

FIG. 26 illustrates an exemplary computing device.

### DETAILED DESCRIPTION

Various technologies pertaining to generation of media content are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to describe one or more aspects.

Moreover, the term “or” is intended to mean an inclusive “or” rather than an exclusive “or”. That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form. Additionally, as used herein, the term “exemplary” is intended to mean serving as an illustration or example of something, and is not intended to indicate a preference.

The various embodiments presented herein relate to generation and provision of media content, e.g., for public presentation, such as a radio broadcast. It is to be appreciated that while the various embodiments are described herein with regard generation of audio content pertaining to an advertisement, whereby the content is audio content to be broadcast by a radio station, the various embodiments are applicable to generation of other media content, such as visual or audio-visual content, to be broadcast over other types of media, for example, over the air television, internet, cable, or satellite. As described herein, the computing system can be operated by the radio station or other entity, and the one or more individuals operate as freelanced employees.

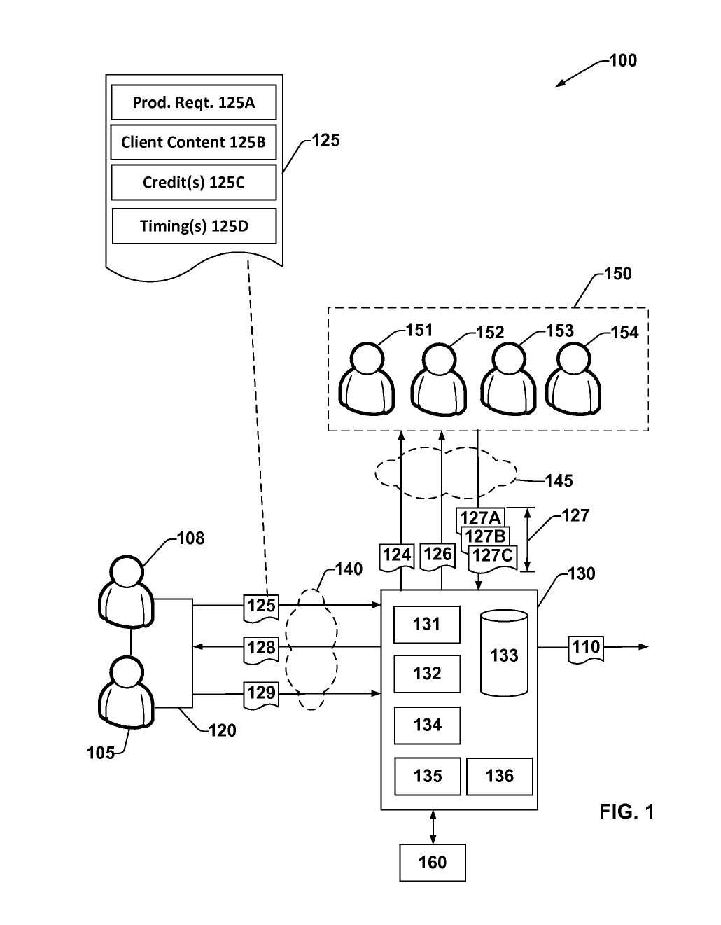

FIG. 1 illustrates a content generation system 100 which can be utilized to generate an advertisement (ad) 110. The content generation system 100, in the embodiment of FIG. 1 comprises an ad request component 120 which is communicatively coupled to a content server 130, wherein the communication between the ad request component 120 and the content server 130 can be via a first network 140. The content server 130 can be operating as a centralized component or system of the content generation system 100. Further, a talent pool 150, specifically, electronic devices associated with individuals in a talent pool 150, is communicatively coupled to the content server 130, wherein the communication between the talent pool 150 and the content server 130 can be via a second network 145. In an embodiment, networks 140 and 145 may, for example, be an intranet, the Internet, a cellular communications network, a satellite communications network.

The talent pool 150 comprises any individuals (or group of individuals) that may have an interest or ability in generating content, etc., to produce the ad 110. For example, the talent pool 150 can include, for example, one or more writers 151, one or more producers 152, one or more musicians 153, one or more voice actors 154 (e.g., such speaker(s) can provide voice samples). As described further herein, the various individuals in the talent pool 150 can access and/or receive a job request 125 for an ad 110 and based upon their interest, skill, etc., they can generate/produce content for the ad 110. As shown in FIG. 1, the various individuals in the talent pool 150 can be in communication with the content server 130 via the network 145, and accordingly the individuals can be located anywhere around the globe, they simply need to have communication access (e.g., whereby, in an embodiment, network 145 is the Internet) to the content server 130.

In an aspect, each of the individuals in the talent pool 150 operate as a ‘freelancer’ whereby they are not directly employed by a company operating the content server 130, or a radio station that is looking to engage the services of one or more individuals in the talent pool 150. For example, an individual, e.g., a voice actor 154 can be self-employed, and in an aspect, only receives payment for work submitted to the content server 130 when the submitted work is selected by a client (e.g., a client 108). While the term ‘freelancer’ is utilized herein, it is to be appreciated that any other term is equally applicable, such as independent contractor, self-employed, etc. The individuals in the talent pool 150 can be engaged in a spot-for-hire basis.

The client 108 can be utilizing the ad request component 120 to submit a job request 125 to the content server 130, whereby the ad request component 120 can be any suitable local device, component, interface, and/or application to enable submission of the job request 125. For example, ad request component 120 can be a software application operating on a computing device, e.g., a personal computer, a mobile computing device, a laptop, etc. In an embodiment, the ad request component 120 is software or a website executed on a computing device owned by the rep 105 or both the client 108 and rep 105. A client or client computing device as used herein means a client owned computing device, or a computing device owned by a rep of the broadcast station, in which case the broadcast station is acting as a client for the requested content. The website may be hosted on the content server 130. The ad request component 120 may also be executed as an SaaS (software-as-a-service) embodiment.

A representative (e.g., a sales representative, also referred to as a ‘rep’) 105 of the radio station, or other entity operating the content server 130, can work with the client 108 to identify the requirements of the client 108 with regard to generating the ad 110 that the client 108 would like to have broadcast. In an embodiment where the content server 130 is being operated by a radio station, the rep 105 represents the radio station. In another embodiment, the content server 130 can be operated by a separate entity (e.g., a business) that provides advertising content to a plurality of broadcast entities, such as radio stations.

In an embodiment, various requirements can be identified for the final ad 110 by a client and submitted as a job request 125, with the rep 105 acting as an intermediary between the client 108 and the content server 130, and accordingly the talent pool 150, with the rep 105 providing guidance to the client 108 with regard to how to generate and/or submit one or more requirements to achieve a goal of generating an ad 110 in accordance with the needs and/or desires of the client 108. The rep 105 also acts in accordance with the radio stations interests to approve or disapprove inappropriate or unwanted content that the radio station will be responsible for.

The job request 125 can include a variety of information, data, and/or requirements. In an aspect, the job request 125 can include a production requirement 125A, whereby a production requirement 125A can specify parameters, such as the following: whether a complete ad 110 is to be generated including text (copy), music, voice, etc., what product, service, or other subject matter the ad pertains to, (e.g. a client wants an ad about their car wash business), what demographic the ad is to be directed to, whether copy is provided by the client 108 and the radio station is to generate an ad 110 based upon the copy, whether copy is to be provided by the client 108 and the radio station is to generate an ad 110 using the copy but with a specific voice style, a run-length for the ad 110 (e.g., is the ad 110 to be 30 seconds long, 1 minute long, etc.), whether the ad 110 is to be a single advertisement or are a number of advertisements to be generated for an advertising campaign, a due-date for completion of production of the ad 110, information regarding how many submissions will be accepted for review by the client 108 (as further described herein), a demographic towards which an ad 110 is to be directed and content should be generated in accordance therewith.

In an embodiment, the system also comprises a formatting component 136. In a particular aspect, a production requirement 125A can include information regarding a specific format for which the ad 110 is to be generated in accordance with. In an embodiment, the requested format will match the format required by the radio stations preexisting system. For example, a first radio station for which an ad 110 is to be broadcast on utilizes a broadcasting format F1, and accordingly, the ad 110 should be produced in accordance with format F1. However, the ad 110 may also be broadcast by a second radio station that utilizes a broadcasting format F2, and hence, the ad 110 should also be produced in accordance with format F2. In an embodiment, radio station may have a saved profile on the content server 130 that specifies the format the station uses. In this case the format information may be automatically generated based on the saved profile for the radio station that originates the job request 125.

A job request 125 can further comprise client content 125B, which can include content provided by the client 108 for incorporation in the ad 110, and/or content for consideration during generation of the ad 110. The client content 125B can include such content as copy (e.g., a particular phrase), a jingle, etc.

As explained further herein, a job request 125 can also include a credit amount 125C, whereby the credit amount 125C can indicate how much a client 108 is to reimburse an individual or group of individuals (e.g., in talent pool 150) for fulfilling a particular aspect or role in production of the ad 110. For example, a first credit amount in the credit amount 125C can indicate that C1 credits are to be paid for copy content, and a second credit amount C2 in the credit amount 125C are to be paid for voice content. As further described herein, a credit amount 125C can be shared amongst a plurality of individuals who are collaborating to generate a submission.

A job request 125 can further include timing data 125D, which can specify, for example, how long an ad 110 is to be broadcast, a calendar window for broadcasting the ad 110 (e.g., during a sporting event that may occur over a number of days, a holiday season, etc.), a specific day(s) for broadcast (e.g., a Sunday, a vacation/holiday, in conjunction with a sales event, etc.), a duration of content, such as a voice recording or music that is to occur during the ad 110 and also respective timings (e.g., start time, end time) for the content, and a specific time of day for broadcast (e.g., the ad 110 is directed towards an adult crowd and hence is not to be broadcast until the late evening).

It is to be appreciated that the scope(s) of one or more job requests 125 received at the content server 130 can be extensive and/or numerous in terms of specific content, copy requirement, production requirement, timing data, etc., and the examples presented here are simply presented to facilitate understanding of the range of information that can be specified in the job request 125.

As previously mentioned, a job request 125 can be received at the content server 130, whereupon any data and content in the job request 125 can be processed at the content server 130, as further described herein (ref. FIG. X). For example, information or data included in a job request 125 can be analyzed by an analyzer component 131 to determine one or more requirements of the client 108 for generating the ad 110. The analyzer component 131 can operate in conjunction with one or more processors 132. For example, the analyzer component 131 can parse the job request 125 to identify information included in the job request 125, where, as previously described, the information can include a production requirement 125A, client content 125B, a credit amount 125C, timing data 125D, etc. In an aspect, the information in the job request 125 can be extracted by the analyzer component 131 and stored, e.g., in a memory storage component 133.

In response to receiving the job request 125 from the client 108 (e.g., via the rep 105 and/or ad request component 120), an ad instruction 126 can be generated at the content server 130 (e.g., by the analyzer component 131) and made available to the various individuals included in the talent pool 150. In an embodiment, the ad instruction 126 can be stored on the content server 130 (e.g., in the memory storage component 133) to be accessed by any of the individuals in the talent pool 150, utilizing a computing device with access to the network 145. In an aspect, a notification 124 can be generated (e.g., an email, a text message, web-page update, or instant message over the internet, etc.) and forwarded (e.g., by a communication component 134) to individuals in the talent pool 150 subscribed (such as by having a unique account with a password and username stored in memory) to the content server 130.

In response to receipt of the notification 124, or simply of their own volition and unprompted by a notification 124, an individual (e.g., a copy writer 151) can review one or more ad instructions 126 to identify any of the production requirement(s) 125A, client content 125B, etc., to determine whether the individual wishes to generate content (e.g., the copy writer 151 generates copy) in accordance with the job request 125. For example, a musician 153 can review the ad instruction 126 to determine what musical content is required by the client 108, and based thereon, the musician 153 can determine whether they will generate musical content in accordance with the job request 125.

In an embodiment, the ad instruction 126 can include information and data contained in any of the job request 125, a production requirement 125A, a client content 125B, a credit amount 125C, timing data 125D, etc., and can be presented on a screen (e.g., on one or more web pages, per FIG. X) which is accessible to any and/or all of the client 108, the rep 105, the copy writer(s) 151, the producer(s) 152, the musician(s) 153, and/or the voice actor(s) 154, or other individual(s) in the talent pool 150.

In an embodiment, a plurality of ad instructions 126 are communicated to the talent pool 150 for review by individuals 151-154. In such a case, an individual may review the plurality of ad instructions 126 and view the requirements of the ad instructions 126. The content server 130 may communicate all the plurality of job requests 125 to the individual in the talent pool 150, or the communicated job requests 125 may be filterable by parameters set by the individual in the talent pool 150 (e.g. a musician may set a filter to include only requests that include musical content or requests that are exclusively for musical content).

Any content generated by the one or more individuals in the talent pool 150 in accordance with the ad instruction 126 can be forwarded from the individual (e.g., a musician 153) to the content server 130, whereby the content can be forwarded in the form of one or more submissions 127. For example, each of the individuals in the talent pool 150 can be accessing and/or communicating with the content server 130 using any suitable local device, component, interface and/or software application (not shown), where such device can include a personal computer, a mobile phone, a tablet pc, etc. Accordingly, an individual can forward (or upload) their content submission 127 from their local device to the content server 130 (e.g., via a communication component 134). For example, a musician 153 can forward musical content as a submission 127A, which can be stored at the content server 130, while a voice actor 154 can also forward a submission 127B that includes a voice over which is subsequently stored at the content server 130 (e.g., in memory 133).

The various submissions can be compiled (e.g., by the analyzer component 131) in response to an ad response 128 which can be forwarded to (or accessed by) the rep 105 and/or client 108. In an exemplary scenario, as further described herein, a plurality of musicians 153 each provided respective musical scores (e.g., submissions 127A and 127C) in accordance with the ad instruction 126. Accordingly, in the exemplary scenario, the ad response 128 can include the plurality of musical scores (e.g., submissions 127A and 127C) which can be forwarded to the rep 105 and/or client 108.

It is to be appreciated that while only three submissions 127A-C are referenced in FIG. 1, any number of submissions can be received, e.g., n-submissions, where n is a positive integer.

In an embodiment, the ad response 128 can be presented on a display screen (e.g., on one or more web pages, per FIG. X) which is accessible to any and/or all of the client 108, the rep 105, the copywriter(s) 151, the producer(s) 152, the musician(s) 153, and/or the voice actor(s) 154, or other individual(s) in the talent pool 150 which may have an interest in viewing the various submissions 127A-n, and/or provided content for the submissions 127A-n.

Upon receipt of the ad response 128, the various submissions 127A-C can be reviewed and therefrom, a submission(s) satisfying the one or more requirements of the client 108, as identified in the job request 125, can be selected. Once the submission(s) (e.g., submissions 127B and 127C) has been selected, an ad content selection 129 identify the selected submission(s) can be forwarded to the content server 130 (e.g., via communications component 134). In an embodiment, the client 108 may have access to review the ad responses 128 through an account on their own computing device, but the final ad content selection 129 can only be made by the rep 105 accessing the content server 130 through the reps account.

The ad content selection 129 can be parsed and the respective submissions (e.g., 127B and 127C) can be made available to a radio station as ad 110. In an aspect, prior to a plurality of submissions being forwarded to the radio station as ad 110, the submissions can be combined (if necessary) to form the ad 110. Per the previous example, the selected submissions are 127C (e.g., musical content from a musician 153) and 127B (e.g., voice content from a voice actor 154). Combination of the submissions 127B and 127C can be performed by a producer 152, as further discussed herein.

In another embodiment, as determined by a parameter of the job request 125, the submissions 127B and 127C are separately transmitted to the computing device of the rep 105, and a producer at the radio station can make the final compilation of the submissions into an ad 110, which may then be uploaded to the content server 130, or directly utilized by the radio station.

Upon selection of a particular submission(s) 127 by a client 108 or by a rep 105 on behalf of a client 108, a respective credit amount (as identified in the credit amount 125C) can be forwarded to the respective individual from the talent pool 150 (e.g., a musician 153 and a voice actor 154) who generated the submission(s) 127 that was selected to produce the ad 110. A credit component 135 can be utilized to process the one or more credit amounts indicated in the credit amount 125C, and further effect payment of the credit amount to the respective individual(s) involved in generation of the submission(s) 127.

Credits can be purchased with money through the credit component or for example through a third-party payment system. Revenue may be generated by the owner of the content server 130, for example, through charging a fee on the purchase of credits, such as a percentage of the credits. Alternatively or additionally, the owner of the content server 130 may also charge a fee when credits are paid out to the talent pool 150.

By effecting payment by a pre-purchased credit system the methodology allows for guaranteed payments to the talent pool if their work is selecting, thereby mitigating the risk of not being paid, which may be a problem in typical freelance scenarios.

In an embodiment, a computing device being utilized by an individual (e.g., any of individuals 151-154) in the talent pool 150 can include a reporting component (not shown) that is configured to report status information regarding the individual to the content server, e.g., the status information indicates whether the individual is available and at the computing device. The status information may be transmitted to a client 108 or a sales rep 105 that is accessing the content server 130 and show up as a notification in a webpage showing profile information of one or more individuals in the talent pool, or further can be presented as a notification on a webpage displaying a content submission by the individual. The status information may also indicate whether the computing device being utilized by the individual (e.g., any of individuals 151-154) is a mobile computing device or a full featured computing device, such as a desktop or laptop computer. In another embodiment, the status information may also include information on advanced audio-visual editing and recording equipment that the individual has available to them. This information may be important to the client or rep who is looking for high quality content to be provided quickly.

Contact information associated with the individual can also be transmitted to the client 108 or the sales rep 105, to enable communication between the individual and the client 108 and/or the sales rep 105 to be conducted, e.g., whereby communication can be by any suitable communication method such as, for example, telephone, instant message, or other internet or cellular network communication.

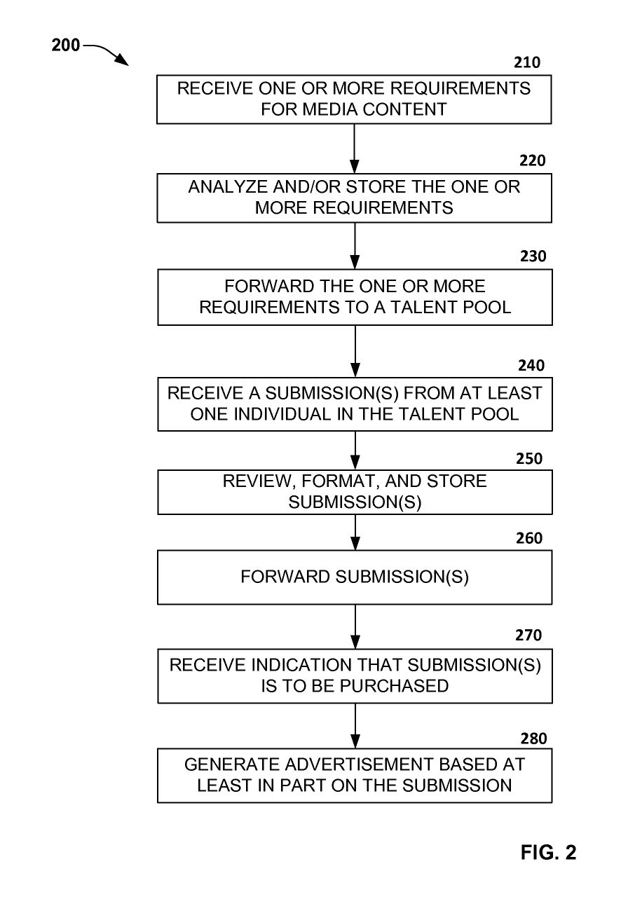

FIGS. 2-10 and 12 illustrate exemplary methodologies relating to generation, utilization, and formatting of advertising and other media content. While the methodologies are shown and described as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement the methodologies described herein

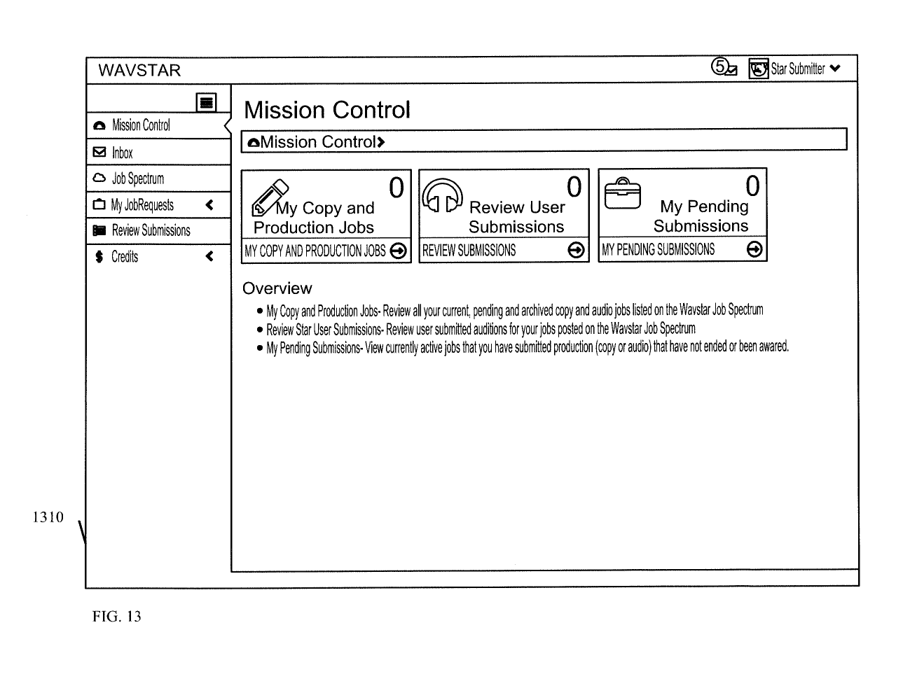

FIG. 2 presents an exemplary methodology 200 for generating media content, such as advertising content, in accordance with one or more client-provided requirements, whereby the requirements define parameters of the media content, or a portion thereof. At 210, a job request can be received at a computing system from a client regarding desired content of an advertisement. The job request can include one or more requirements regarding a final state of the advertisement. The job request can be generated by a client, whereby the client is interfacing with the computing system and/or uploading information (e.g., the one or more requirements) to the computing system from a remotely located device, component, interface, software application, etc., whereby the device can be a personal computer, a mobile computing device, a laptop personal computer, and the like. In an embodiment, the computing system can be a server (also referred to herein as a content server), a centralized computing system, a cloud based system, etc. The one or more requirements can include information such as a production requirement, a format requirement, client content, a credit amount, timing data, etc., as previously described (and e.g., per FIGS. 13-16).

At 220, the job request can be analyzed by an analysis component, whereby the analysis component can be located and execute instructions at a centralized computing system. The analysis component can parse the job request to extract and/or separate out information and/or content (e.g., any of the production requirement, the format requirement, the client content, the credit amount, the timing data, etc.). The information can be stored at the computing system, for example, in a memory component located at, or in communication with, the computing system. In an aspect, the extracted information can be assigned to a production order, whereby the production order may contain itemized information pertinent to the job request. The production order may for example, include the name of the client generating the job request, contact information for the client, a contract number (e.g., generated by the analyzer component), a radio station representative assigned to the client (e.g., a sales representative), an audio cart number (an identifier for the radio station to play the content at a certain time spot), and a specified media format.

A unique identifier can be generated to facilitate tracking, content association, and crediting, of information and/or content (e.g., a submission) generated in association with the job request. In an aspect, as described further herein, the unique identifier can prevent submissions from being plagiarized. The identifier also facilitates a feature of the system that content having a low quality format is submitted to a client for review while content having a higher quality format (e.g., production quality content) is withheld from the client until the submission is selected and crediting for the submission has been conducted.

At 230, the one or more requirements can be forwarded to a talent pool, whereby the talent pool can comprise of one or more individuals. As previously described, the individuals are not employees of the company generating the advertisement, but rather are a freelance worker(s). Functionally, this is reflected in the system and method, by the pre-purchased credit payment system described above, whereby individuals in the talent pool are only credited once their submission is accepted.

In an embodiment, the individuals can subscribe to the computing system such that as a new job request(s) is received at the computing system and parsed by the analysis component, an individual can be informed that a newly received job request includes at least one requirement that may have interest to the individual. For example, upon parsing the job request the analyzer component indicates that the job request includes a requirement for copy to be submitted for the advertisement. During a registration process with the computing system an individual can indicate what sort of content they are interest in, e.g., copy-writing, music, vocals, production, etc. Accordingly, the requirement for copy to be submitted can be forwarded to any individual that has indicated they are a copy-writer.

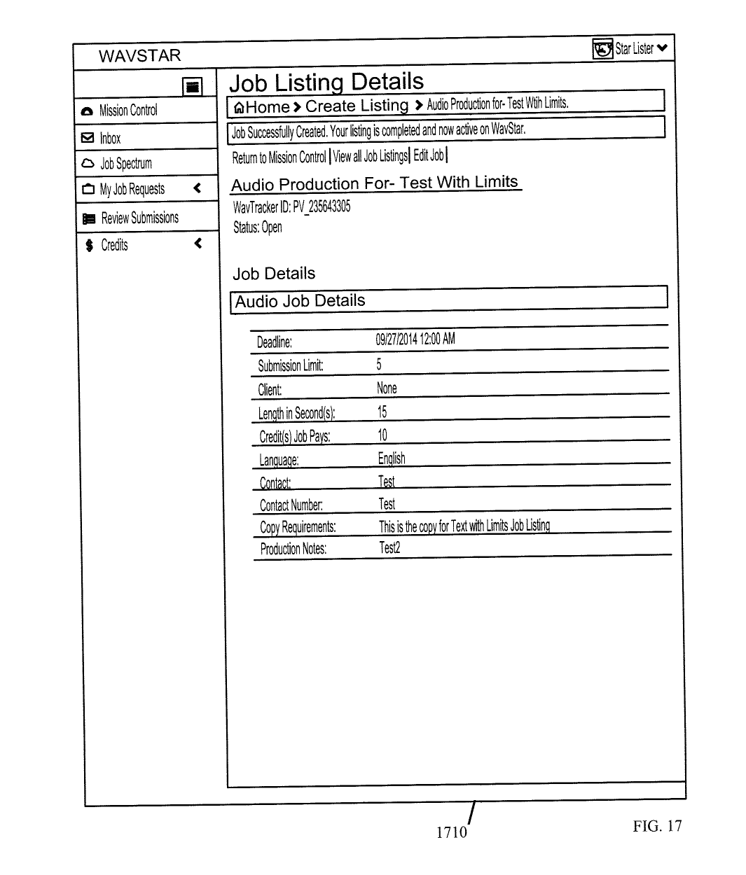

In an alternative embodiment, a plurality of job requests which are stored at the centralized server, and are currently in an ‘open state’, e.g., are requiring submission of one or more items of content from the talent pool, can be presented on a job listing screen (e.g., a web page). Accordingly, an individual who has subscribed to the advertising generation system can review the job listing(s) and identify whether there is any requirement(s) or content that is of interest to the individual (e.g., per FIG. 17).

At 240, one or more submissions can be received from at least one individual in the talent pool. As previously mentioned, a job request can include any content requirement, such as, for example, a music requirement, a copy requirement, a voice sample requirement, and/or a production requirement. Accordingly, based upon the requirement(s), one or more submissions can be received. For example, a requirement may exist for a musical score to be generated, whereby at least one or more individuals (e.g., one or more musicians) submit musical scores to the computing system for forwarding to, and review by, the client. A submission cannot be retrieved by a client who was not responsible for submission of the original job request, e.g., a client has to engage with one or more individuals in an honest manner to ensure that the one or more individuals are appropriately reimbursed for their submission(s). Other safeguards in certain embodiments discussed herein can be utilized to ensure that submissions generated by individuals in the talent pool are correctly credited if they are selected for use by a client.

At 250, the one or more submissions generated by the one or more individuals in the talent pool can be received by the content server and reviewed by the analyzer component to ascertain that the one or more submissions are in a correct format for review by a client and/or broadcasting by a radio station.

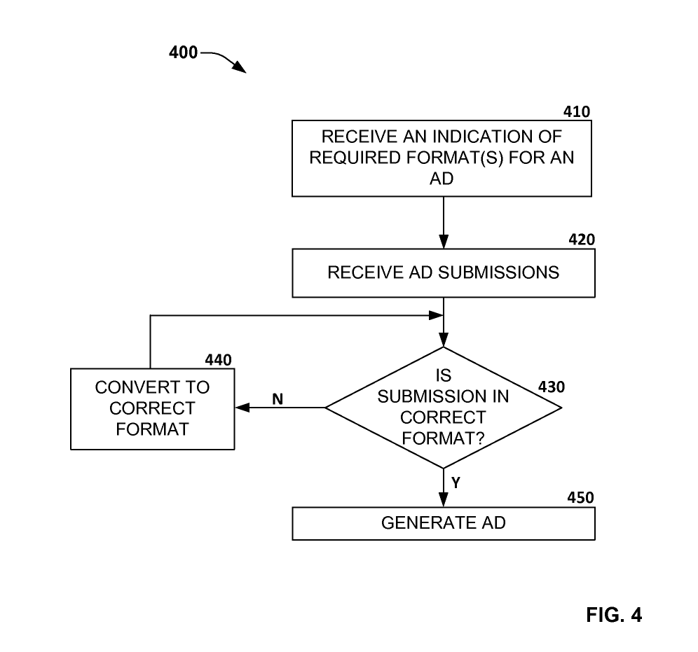

In an embodiment at 250, the submission may be reformatted at the content server to match the format specified in the job request requirements. Alternatively, the reformatting may be done to match a uniform format for delivering the content submissions for review and selection by the rep or client, such as a format that is less data intensive and of lower quality. In an embodiment, only after the final selection is made, the original selection is reformatted to meet the requirements of the job request. If a low quality version is used for submission the original high quality version is stored at the server in memory, and is made available to the client upon purchase (whereby credits are transferred to the creator) of the submission. In an embodiment, instead of low data quality, a shortened version of the high quality submission may be used as the low quality version. The various submissions, e.g., in low and high quality formats, can be stored (or archived) at the central computing system, whereby the submissions can be stored with a unique identifier, which identifies the individual that submits the content and the date and time when the individual transmitted the submission to the content server. An embodiment of the reformatting step is also explained in FIG. 4.

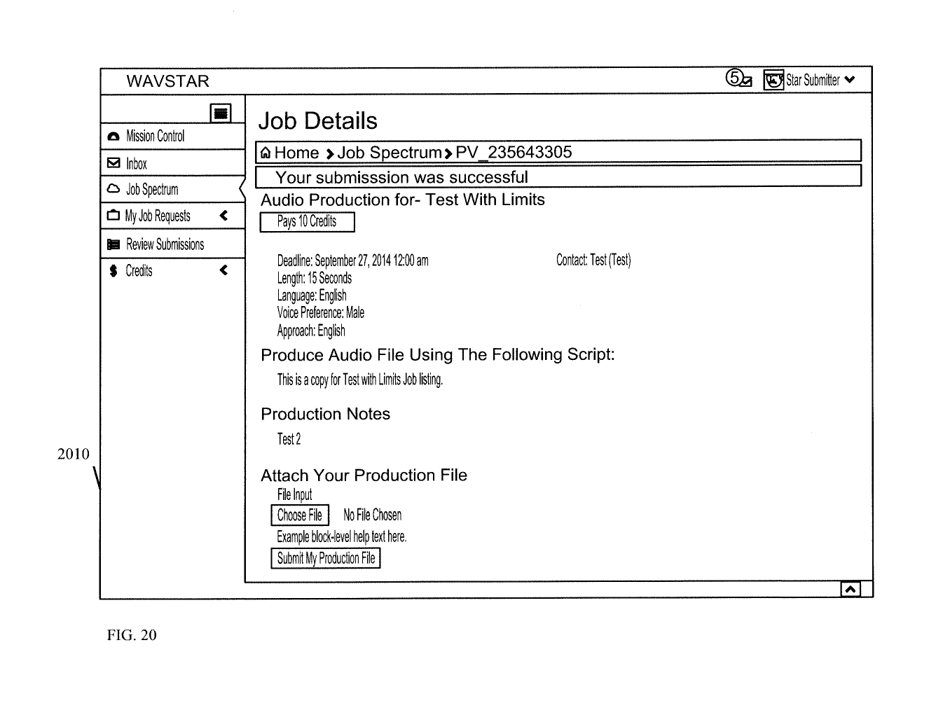

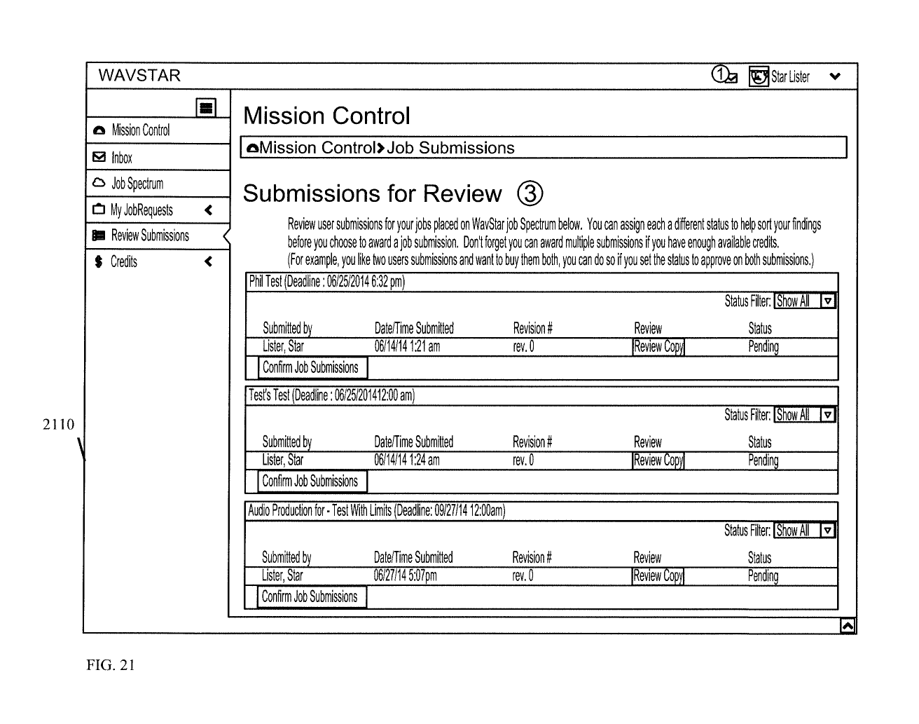

At 260, any submissions received which pertain to a particular job request can be forwarded to the client. As mentioned, while in the review process a low quality version of the submission received from the individual can be forwarded for review. In this embodiment an indicator of the quality of the original submission may also be provided to the client, such as an abbreviated high quality audio file, or a numerical indication of the data quality, e.g. size (in megabytes) of the original submission file. Upon receiving the submission(s) the client can select one or more submissions for further review, final production, etc., (e.g., per FIGS. 20 and 21).

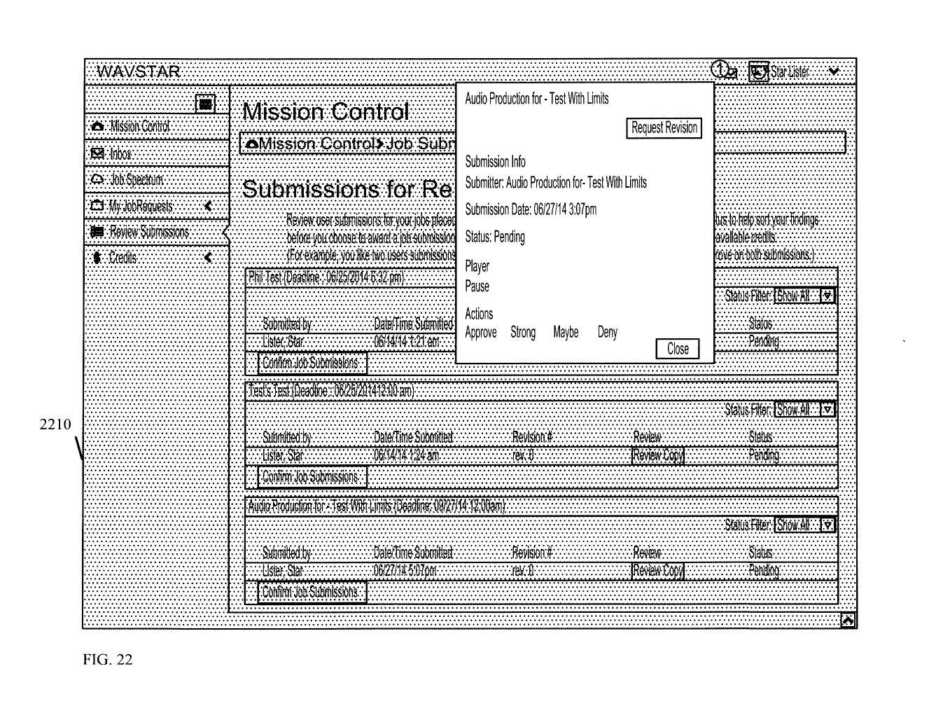

At 270, one or more indications can be received from the client that one or more submissions have been selected to be of interest to the client. In an aspect, the client may have provided client content comprising copy and voice for an advertisement and the job request simply requested a musical score be generated based upon the copy and/or voice. Hence, it might be a simple operation to combine the musical score with the copy/voice and no further work is required from the one or more individuals included in the talent pool. Accordingly, an indication can be forwarded to the individual who created the selected musical score that the client has purchased the submission (e.g., per FIG. 22) and the individual can receive a credit amount identified for the musical score in the job request.

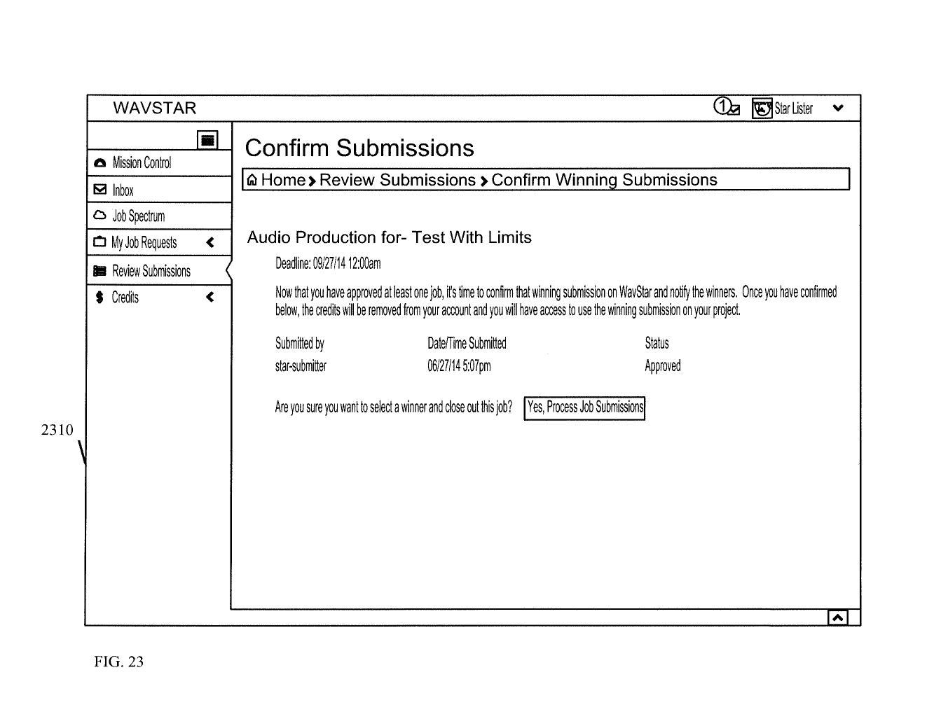

At 280, an advertisement with the client provided copy/voice can be generated in conjunction with the musical score generated by the individual in the talent pool (e.g., per FIG. 23). Alternatively, the job request may have included a request for copy, voice, a musical score, and a finalized product. Hence, a number of iterations of various acts presented in FIG. 2 may occur during generation of an advertisement. For example, on an initial iteration, submissions for the copy are received, from which one is selected. A job request can be initiated for a subsequent iteration such that voice and music are to be generated for the copy. Hence, a second iteration can occur whereby voice and music are generated by one or more individuals in the talent pool, from which the client selects the submission(s) that fit their requirement(s) and/or vision for a particular advertisement. A third iteration can occur whereby a job request is generated requesting a producer generate an advertisement which combines the copy, voice and music. Accordingly, one or more producers in the talent pool can generate ‘final draft’ advertising submissions that combine the copy, voice, and music. The ‘final draft’ advertising submissions can be forwarded to, and reviewed by, the client, whereupon the client can select a draft advertising submission that is to be utilized as their advertisement. Accordingly, the producer in the talent pool that generated the selected ‘final draft’ advertising submission, can receive a credit amount for their submission.

In an embodiment software tools may be provided through the content server to for generating the individual portions of the content and for combining the portions into the final draft. These tools may be utilized by the talent pool or also the subscribing radio station, e.g. a station that employs a producer to finalize and combine the portions of the content in-house.

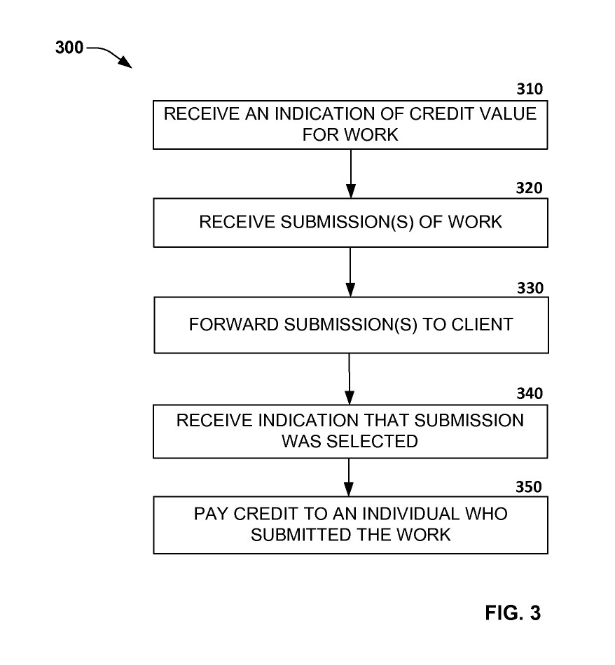

FIG. 3 presents an exemplary methodology 300 for paying a credit amount to an individual whose submission was selected by a client. At 310, an indication can be received indicating a credit amount that will be paid for a piece of content to be generated and/or selected as part of generation of an advertisement, or portion thereof.

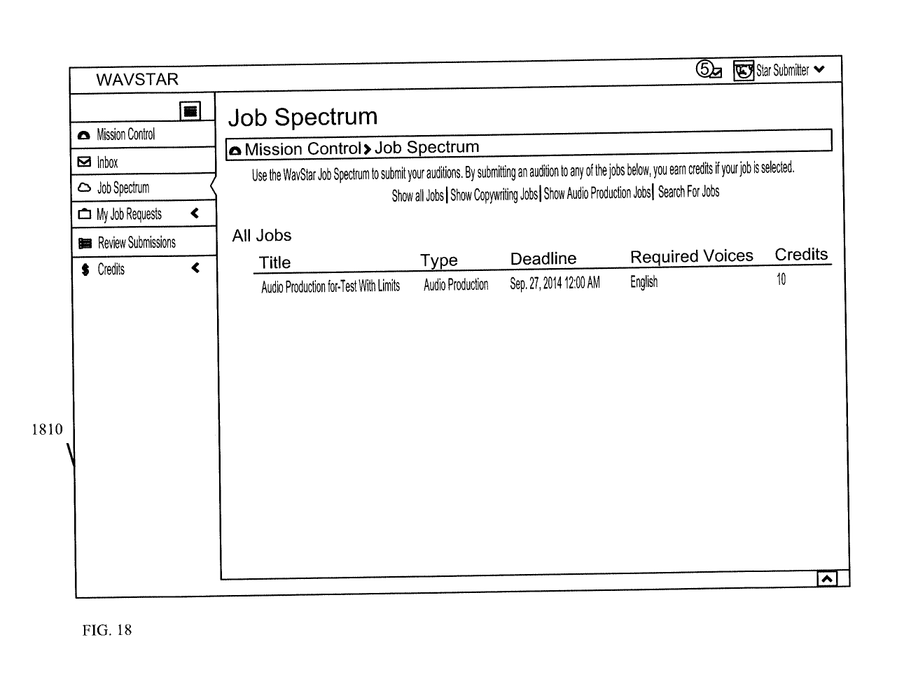

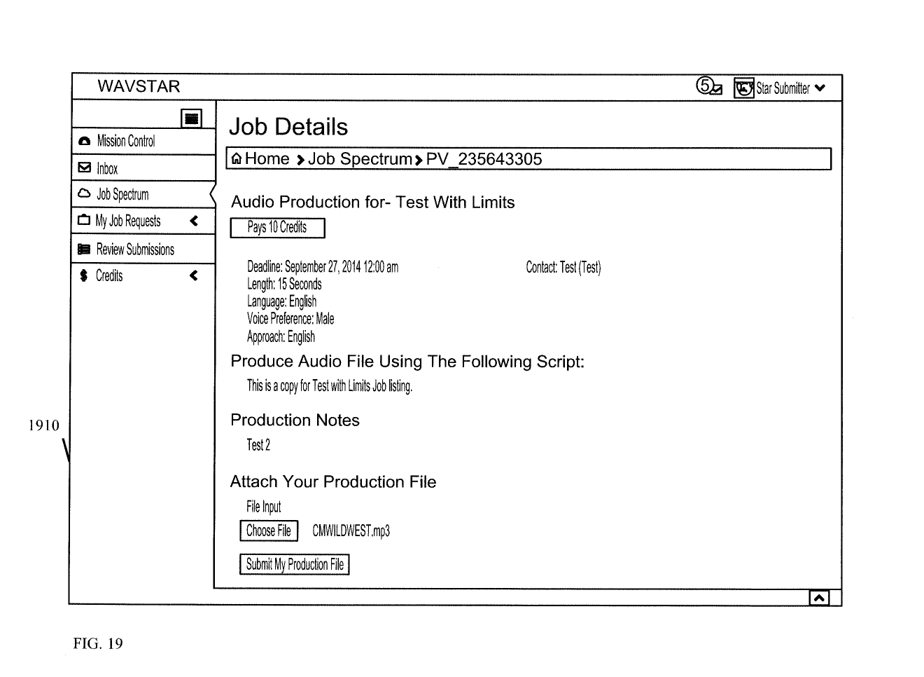

At 320, in response to a job request being posted at a computing system, and further, the job request being made available for review, one or more submissions are received from one or more individuals in a talent pool, wherein the one or more submissions pertain to one or more requirements in the job request, as previously described (e.g., per FIGS. 18 and 19).

At 330, the one or more submissions are forwarded from the centralized system to the client and/or rep, whereby, as previously described, the one or more submissions can be reviewed by the client and/or station rep.

At 340, an indication can be received, at the computing system, that a particular submission was selected by the client (e.g., per FIG. 22).

At 350, the credit amount for the submission, as established at 310, is identified, and accordingly, the credit amount is credited to the individual who generated the submission that was selected by the client.

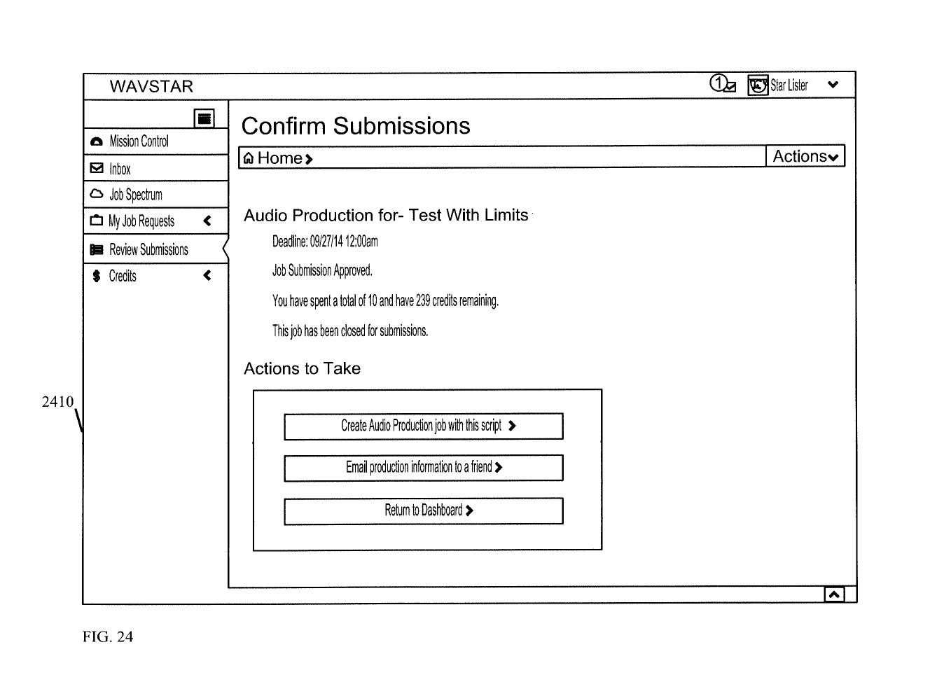

In an embodiment (e.g., per FIG. 24), the credit amount can simply be exchanged for a monetary amount by the individual. In another embodiment, the credit amount can be exchanged for one or more items that are offered by the entity operating the computing system, whereby the items can be a product(s), a service(s), etc. In an aspect, the one or more items can be offered for a credit amount which is less than an equivalent monetary amount at a retailer (e.g., a physical store or an on-line store), thereby increasing the likelihood that the one or more individuals will be engaged in submitting content for potential use in an advertisement.

It is to be appreciated that while the methodology 300 is directed towards an individual receiving a credit amount based upon selection (e.g., by a client) of a submission provided by the individual, other conditions for an individual receiving credit exist. For example, if a particular individual is generating submissions and/or content that are deemed to have a high value for any of a client or operator of the centralized system, then the individual can be paid a ‘retainer’ credit amount to increase the likelihood that the individual may be available to receive future job requests. Hence, the individual may be providing a revenue stream for the operator of the centralized system, and even though the individual may not be interested in providing a submission(s) for one or more requests pending at the centralized system, the individual is incentivized to remain available based upon the retainer credit amount.

FIG. 4 presents an exemplary methodology 400 for ensuring a submission is in a correct format. At 410, an indication can be received, e.g., in a job request generated by a client, identifying one or more formats required for a final advertisement, or a portion of a final advertisement. For example, a first radio station for which an advertisement is to be generated for utilizes a broadcasting format F1, and accordingly, the advertisement, and any portion thereof, should be produced in accordance with format F1. However, a second radio station may utilize a broadcasting format F2, and hence, any advertisement, or portion thereof, should be produced in accordance with format F2. In an aspect, both the first and second radio stations may be scheduled to broadcast the same advertisement required by a client, and accordingly, the advertisement, or portion thereof, may have to be generated in both the format F1 and the format F2.

At 420, one or more advertising submissions can be received from one or more individuals in a talent pool associated with a computing system (e.g., an advertisement generation system).

At 430 the one or more submissions can be reviewed to determine whether the submissions are in the requested format. Review of the one or more submissions can be conducted by an analysis component associated with the computing system, as explained above.

At 440, in the event of the one or more submissions being determined to be in the wrong format, the one or more submissions can be reformatted to the required format. Upon conversion to a correct format, the flow can return to 430 for the format evaluation to be conducted once again. One or more software tools may be used to provide the conversion of formats.

At 450, in response to, at 430, a determination being made that the submission is in the correct format, the final advertisement, or portion thereof, can be generated.

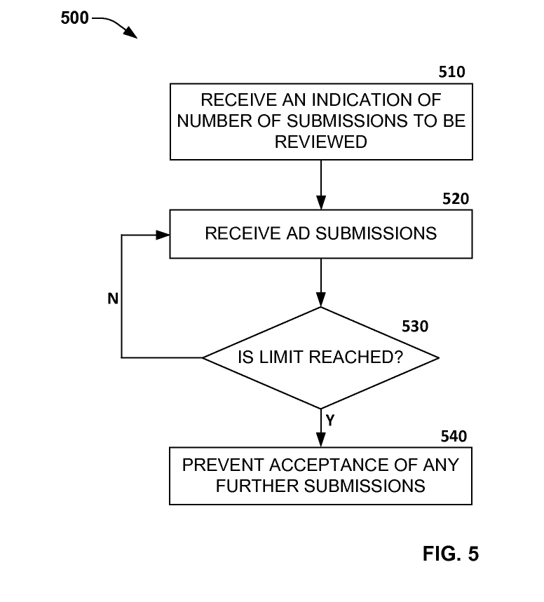

FIG. 5 presents an exemplary methodology 500 for controlling a number of submissions that can be submitted in response to a job request generated by a client. At 510, an indication of the number of submissions which are to be reviewed can be received at a computing system, wherein the indication can be received as part of a job request generated by and received from a client. In an aspect, a number of submissions that can be submitted in response to a job request can be limited for various reasons, where such reasons can include for example, a client only wishes to review a limited number of submissions or the client wishes to incentivize the talent pool individuals by providing them with a set chance for having their selected, e.g. a 1 in 10 chance rather than 1 in an unlimited number. Hence, rather than having to control a number of submissions based on a cutoff time, the number can be controlled based upon an actual limit.

At 520, a number of submissions can be received from one or more individuals in the talent pool. In an aspect, any number of submissions can be submitted by an individual in the talent pool, until the total number of stipulated submissions has been reached. Alternatively, a total number of submissions can be set, as well as a limit on how many submissions a particular individual can submit. For example, a client may set a total number of submissions that can be submitted for review at 15 submissions, while the client may further limit a number of submissions that can be submitted by an individual to 2 submissions. It is to be appreciated that numbers are exemplary and any numbers can be set as desired by the client.

At 530, a check can be performed to determine whether the client defined limit has been reached, or not. In the event of NO, the limit has not been reached, the flow can return to 520, whereby a further submission(s) can be received.

At 530, in the event of YES, the limit has been reached, the flow can continue on to 540. At 540, the ability for one or more individuals in the talent pool to submit a submission can be prevented. In an embodiment, a flag notifier can be placed on a screen detailing the requirement request, whereby the flag indicates that no further submissions are being accepted for this request at this time. Alternatively, in an embodiment, for any individuals that have not submitted a submission for the requirement request, the requirement request may no longer be visible.

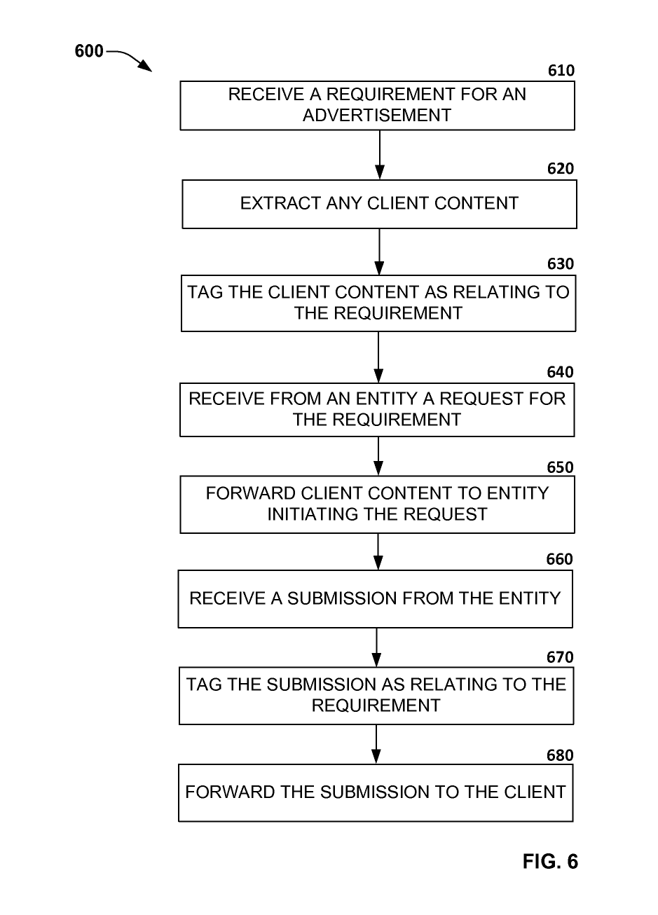

FIG. 6 presents an exemplary methodology 600 for incorporating client content into a requirement request, and accordingly, making the content available to one or more individuals in the talent pool.

At 610, a job request can be received for an advertisement desired by a client. As well as providing an indication of the various requirements pertaining to an advertisement, as previously described, the job request can also include content provided by the client. In an aspect, the client content can be provided by the client for the content to be incorporated in an advertisement and/or to be considered during generation of the advertisement. The client content can include content such as, for example, copy (e.g., a particular phrase), a particular jingle, or a particular sound effect. Further, the client content can be in any suitable format, for example, a jingle can be submitted in one or more audio file formats, such as .MPEG, .WAV, .FLAC, .MP3, .WMA, etc. Similarly, a copy can be submitted as a word document, a .PDF file, an .XML file, etc. In an aspect, the file format can be such that it is able to be viewed, processed, etc., by as many individuals in the talent pool as possible. Further, the file format can be selected to minimize memory requirements, thereby enabling the client content to be easily forwarded to individuals who request the content without having to be concerned with bandwidth issues (e.g., of one or more networks over which communications between any of the centralized system, the client, and the one or more individuals in the talent pool are being conveyed).

At 620, a requirement request can be analyzed and/or parsed to enable extraction of the client content from the requirement request.

At 630, to enable the client content to be associated with the requirement request, the client content can be tagged (e.g., with a production identifier, or the like). The requirement request and the tagged client content can be stored at the centralized computing system.

At 640, a query can be received from one or more individuals in the talent pool regarding the requirement request. For example, the query can be forwarded from an individual in response to the individual receiving an indication that the requirement request has been received such as by a direct notification and/or reviewed such as by the individual accessing a webpage.

At 650, in response to receiving the request, the centralized computing system can forward the client content to the individual who initially submitted the query.

At 660, a submission can be received from the individual, wherein the submission has been generated in consideration of the content. For example, the client content can be a jingle that is to be included in the advertisement, and accordingly, the submission includes the jingle incorporated into the advertisement submission.

At 670, the submission can be tagged as pertaining to the requirement request.

At 680, the submission can be forwarded to the client or rep. For example, the client can request all (or a portion) of the submissions that have been generated for a requirement request to be forwarded to the client for review. Optionally, at this point the client may desire to put together the final production on their own or put the full set of portions of the ad including the client content and the submission content into a job request for a producer in the talent pool to produce the final advertisement.

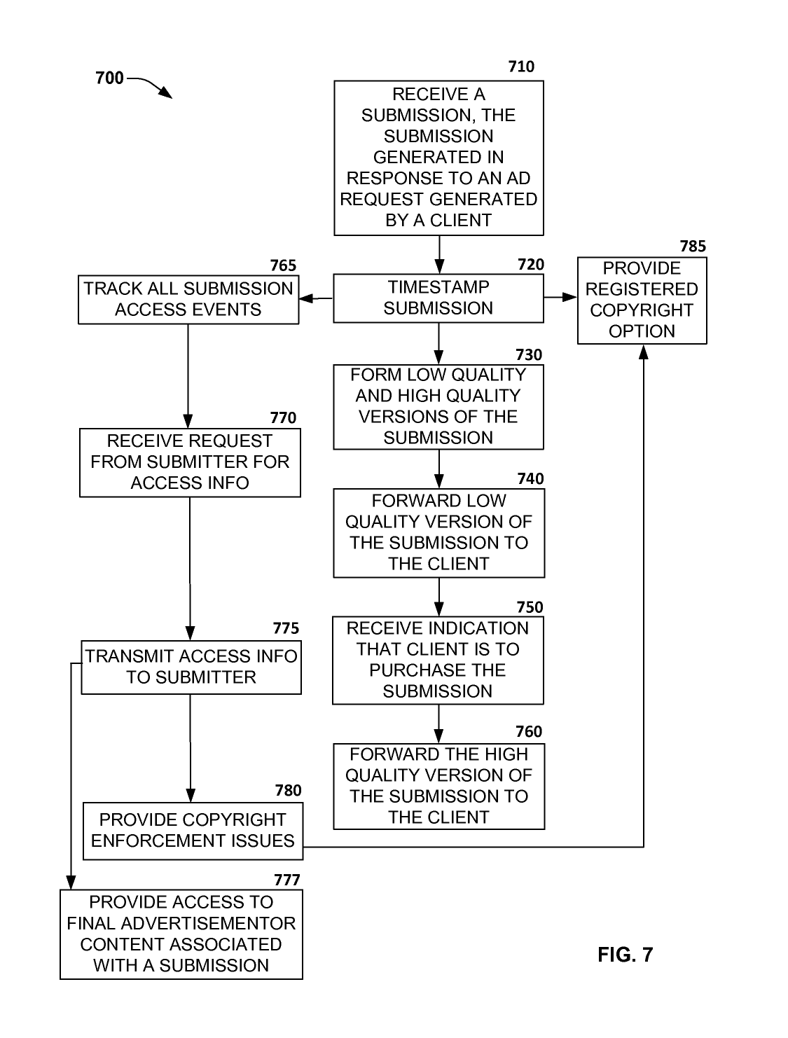

FIG. 7 presents an exemplary methodology 700 for providing protection from copyright piracy and intellectual property theft, thereby protecting a submission from an individual generating media content. At 710, a submission can be received at a centralized system, wherein the submission is generated in response to a requirement request received for an advertisement desired by a client. As previously mentioned, an individual can generate one or more submissions in response to a requirement request for an advertisement.

At 720, a timestamp can be applied to the submission, wherein the timestamp can be an indicator of a time at which the submission was received at the centralized system from the individual.

At 730, various quality versions of the submission can be generated. In an aspect, a high quality version can be generated and forwarded to the centralized system from the individual. However, to protect the rights of the individual (e.g., intellectual property rights such as copyright) a low quality version can be generated at the centralized system for forwarding to the client, while the high quality version can be retained at the centralized system. Accordingly, the client receives a low quality version from which they can readily ascertain whether the submission is of interest to them.

At 740, the low quality version (e.g., in response to a request from the client) is forwarded to the client.

At 750, an indication that the client wants to utilize (e.g., purchase) the submission can be received at the centralized system. Accordingly, as described elsewhere, owing to the purchase, the individual who generated the submission can receive a credit for their submission.

At 760, based upon the client purchasing the submission and a credit being forwarded to the individual generating the submission, the high quality version of the submission can be forwarded from the centralized system to the client.

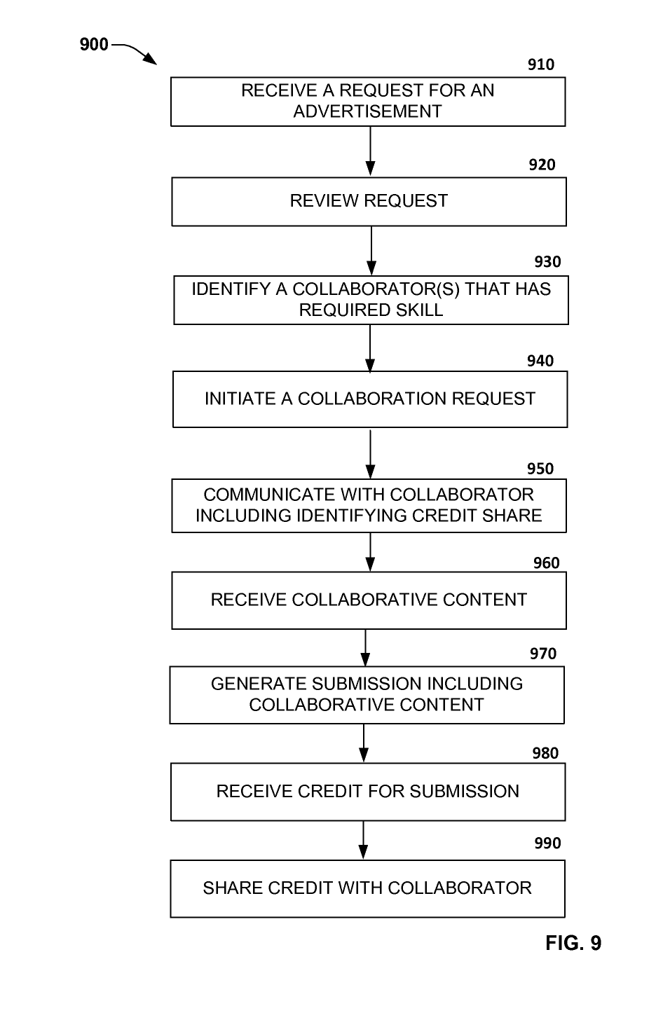

In a separate feature of the protection methodology, after time-stamping and storing the submission at 720, at 765 a computing system such as the content server tracks all access events to the time-stamped submission. Access events include every partial or full download or transmission of the submission to another registered member on the system. The access event information includes information to identify the individual, e.g. a client, radio station rep, or other talent pool member, that accessed the submission. The identifying information may be based on profile information gathered when the individual subscribed to the system. See FIG. 9 which explain the subscription and profile methodology. The access event information may be stored in memory, such as in a log or register.

In an embodiment where the submission is a collaborative work, a first submission is time-stamped and access event logging begins. Later a second submission is accepted by the submitter and added to the first submission, e.g. the first submission is a lyric and the second submission is a musical tune for the lyric. A time stamp is created for the collaborative work and two submitters are identified as associated with the collaborative work. In an embodiment, the methodology proceeds as stated below with each submitter having the same rights and options based on the time-stamp and access event information. In an embodiment, for example, if the first submitter purchased the second submission from the second submitter along, then the first submitter may only receive the rights and options stated below. If the second submission was received in response to a job request, then the centralized system could automatically keep track of the owner of the collaborative content for the purposes of who receives the rights and options stated below.

At 770 a request for the access information is received (e.g. by the content server) from the individual that provided the submission (the “submitter”). In an embodiment, the submitter must be logged-in and registered on the system so that the submitter may be recognized. In an embodiment, a webpage may be presented to submitters showing a list of all their submissions and allowing them to select to request the access event information for each of them.

At 775 the access information is transmitted (e.g. from the content server) to the computing device of the submitter. This provides the submitter with a method to police the content that they author from unauthorized use and copyright infringement. For example, in contrast to websites that allow posting and sharing of original content and viewing by public members anonymously, the methodology of FIG. 7 allows the author of submitted content to track who has viewed their content so that access to the content can be proven, and copying can be more easily shown.

At 777, as a further feature to help police unauthorized use of content, the access information may include a selectable option such as a link for the submitter to review the final ad or final content (e.g. ad 110, as explained above) that was associated with the submission, that is the final content resulting from the job request that the submission was made in response to. This allows the submitter to check, for example, that the low quality sample or a lyric that was provided for review was not resubmitted as client content and used as part of the final content.

In an example, an individual may write a lyric to a song and submit it through the content server in response to a job request, and the submission is not accepted. Later, the individual hears a song on the radio that matches their submission and concludes that the submission is related to the job request. The individual can then determine through the access information that the client or rep associated with the job request they responded to, in fact, accessed their content. The individual can also prove by way of the time stamp when they created their work and that they are the creator of the lyric. The methodology thus protects the individual submitter of content and enhances their ability to show unauthorized use or infringement of their intellectual property. While this methodology is described in the context of showing copying of audio and written content, it is also applicable to visual and audio-visual content. It can also be applicable for protecting ideas by showing access of others and potential for copying, and for showing authorship/inventorship, such as, for example, in a joint development or collaboration exercise.

At 780 an additional step of providing copyright enforcement options may also be performed. For example, the content server may transmit one or more selectable options, such as: reporting unauthorized use to an administrator of the content server, contacting the individual that accessed the submission about unauthorized use, initiating a dispute resolution procedure controlled by the administrator of the content server. These options, may, for example, be presented on a webpage to the submitter. In certain cases, the administrator may elect to take action against the accused infringer by suspending their account, by putting a hold on their credits, or by transferring credits to the individual, so long as such actions are allowed by the terms of service agreed to by the parties, which may be a required agreement at subscription to the service. An agreement not to make unauthorized copies of others works, may also be required as part of the terms of service. Reports of unauthorized use may also be attached to the profile of the client or rep or talent pool member and show up as notifications in future job requests.

At step 785 a further option is provided to the submitter of the content to obtain a registered copyright or equivalent protection with one or more governmental entities. The administrator of the content server or a contracted third party may provide this service at a cost to the submitter, which may, for example, be paid for in credits the submitter has earned or through another payment system. Further information may be required from the submitter to accomplish this task, but it is contemplated that much of the necessary information for applying for a copyright can be automatically populated from the submitter's profile and the time-stamped and stored submission. This option may be presented to the submitter, at various times, such as after the submission and timestamp at 720, when the access information is transmitted at 775, or when the copyright enforcement options are provided 780.

An additional feature for policing unauthorized use is a search feature, wherein a submitter can perform key word, phrase, image, or even audio clip searches of the content server repository of content to find content that they think matches their own work of authorship. A filter may be applied to only search content by users that have an access event to a submission from the individual, thereby providing a targeted search for persons with known access to the individual's works.

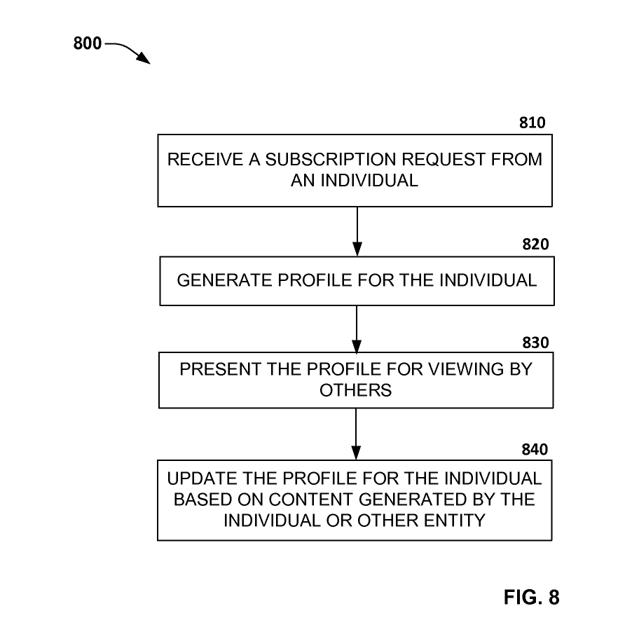

FIG. 8 presents an exemplary methodology 800 for generating a profile for an individual in a talent pool and updating profile content. The methodology may also be used to generate a profile for a client and/or rep that will submit job requests. At 810, a subscription request can be received at a centralized system, such as the content server, whereby the request can be generated by an individual who wishes to provide or solicit advertising content in accord with one or more job requests received at the centralized system from a client. As previously mentioned, the individual can be a freelancer, i.e. receiving remuneration through the system on an accepted submission basis. In an embodiment, the submission request includes information in response to a form requiring, for example, contact, background, location, and financial information of the individual. In an embodiment that provides enhanced protection from unauthorized use of content, the system may optionally require a form of verification of personal and location information, e.g., a copy of driver's license, utility bill, or rental agreement.

At 820, a profile page can be generated for the individual.

At 830, the profile page can be available for presentment to one or more other individuals or other entities. For example, a client or rep who is requiring an advertisement to be generated can access the individual's profile page and review information which is pertinent to the individual, where such information can include an individual's name, background information, contact information, one or more examples of previous worked created and/or submitted by the individual, the sort of work the individual is likely to perform, etc.

At 840, the profile page can be updated with information provided by the individual, e.g., a submission that the individual has worked on, client feedback/rating, plagiarism complaints, or endorsements, or information relating to job requests the individual has worked on.

FIG. 9 presents an exemplary methodology 900 for generation of collaborative content, which may be for advertisement, or portion thereof, but may be for generating any media content, such as a song or a full album. At 910, a job request can be received at a centralized system, wherein the job request can be generated by a client requiring an advertisement.

At 920, the job request can be reviewed by an individual in a talent pool. Upon reviewing the job request, the individual makes the determination that the job request includes a requirement that includes one or more skills that the individual will need assistance with to comply with the request.

At 930, the individual can identify one or more collaborators who may have a skill(s) applicable to generating a submission in accordance with the requirement. In an embodiment, the individual can access a page that displays a list of various individuals and their skills. Hence, the individual, who may be a writer, is requiring voice talent to read their copy. The individual can enter a search for any individuals that may be able to provide a particular voice, e.g., that has been requested in the requirement. For example, the job request that the individual wants to work on has a requirement for a script to be generated that includes a voice which is a deep male voice. The individual, being female, cannot perform the deep male voice, and hence, by performing a search of those individuals in the talent pool that have the required voice, e.g., ‘deep male voice’, one or more collaborators can be identified. In an embodiment, the individual can access a profile page(s) of a potential collaborator(s) and review voice files that the collaborator has submitted to their profile page to enable the individual to determine whether the potential collaborator has the voice they are looking for.

At 940, the individual can initiate a collaboration request with the collaborator who can assist the individual in providing a submission in accordance with the requirement of the job request, e.g., the collaborator has the required ‘deep male voice’.

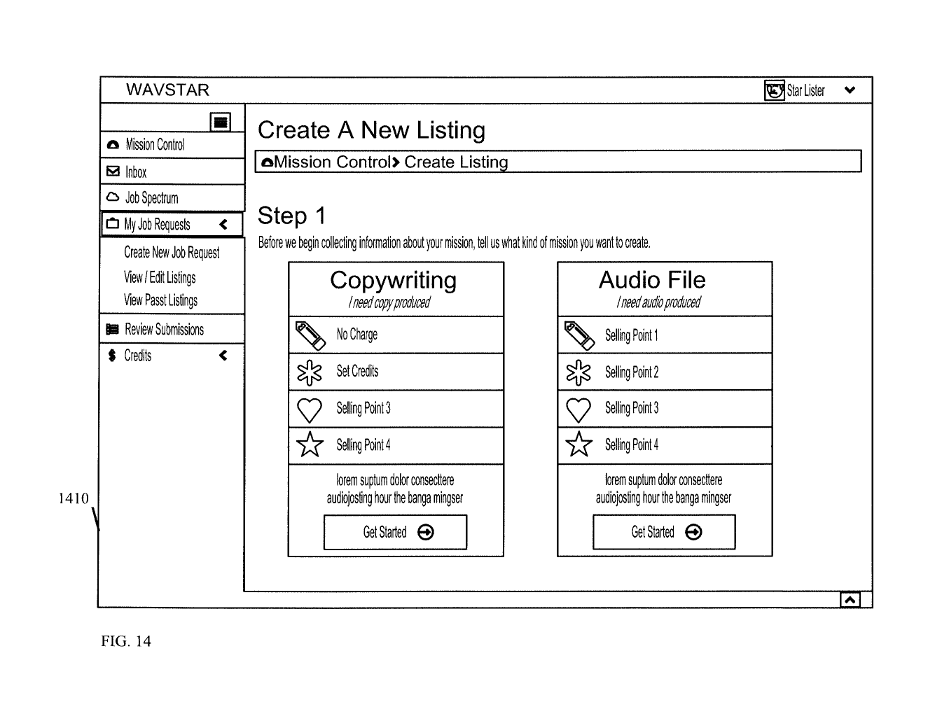

At 950, in response to the collaborator engaging communication with the individual, a portion of a credit amount can be assigned to the collaborator for their assistance with generating a submission, wherein the credit amount can be the credit amount that has been ascribed by a client for the submission, as previously described (e.g., per FIG. 14).

At 960, the individual and the collaborator can collaborate in generating content for submission in accordance with the job request. In an embodiment, the individual can generate the copy to which the collaborator performs the voice-over. In an embodiment, the collaborator can forward the voice-over (e.g., an MPEG file, etc.) to the individual, whereby the forwarding can be via the centralized system (e.g., to provide intellectual property coverage) or privately.

At 970, the individual can forward the submission, including the voice-over, to the centralized system, whereby, as previously discussed, the submission can be made available for review to the client.

At 980, as further previously discussed, upon selection of the submission by the client, the individual can receive the credit amount assigned in the job request for the advertising content.

At 990, the credit amount can be shared by the individual and the collaborator. For example, where a credit amount of 80 credits was assigned by the client for generation of the advertising content, the individual and the collaborator may have reached an agreed share of 45 credits for the copy (e.g., payable to the individual) and 35 credits for the voice-over (e.g., payable to the collaborator). Accordingly, the individual and the collaborator can receive payment of their respective credit amounts, whereby the payments can be made by the centralized system to respective accounts of the individual and the collaborator. As previously described, a timestamp for each transaction can be recorded at the centralized system, such as a timestamp of the credits being issued, to whom, amount, content provided, etc., whereby every step in the collaborative process can be recorded and kept on file at the centralized system. Accordingly, if the intellectual property rights of the individual, the collaborator, the client, etc., are subsequently questioned, particularly in regards to one or more aspects of the collaboration, there is a channel of recourse and a time-stamped record for each event occurring during the existence of the collaboration.

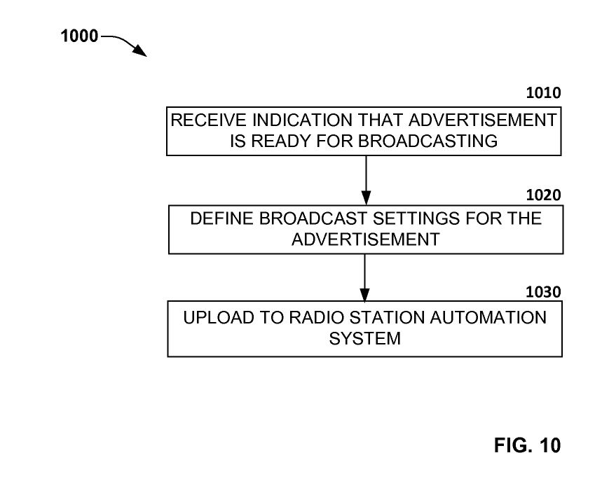

FIG. 10 presents an exemplary methodology 1000 for uploading content, such as an advertisement, to an automation system in readiness for broadcasting of the advertisement. At 1010, once an advertisement has been created and is ready for broadcasting (e.g., the advertisement has been selected by a client and/or radio station, credits have been transferred to individuals involved in creating the advertising content, etc.) the completed advertisement (e.g., for a radio transmission, an audio-production) can be forwarded to the radio station. In an embodiment, the completed advertisement can be automatically forwarded (e.g., without any human interaction) from the centralized system to an automation system of the radio station. In an aspect, the completed advertisement can be tagged at the centralized system with pertinent information regarding which radio station is to receive the completed advertisement, whereby the information can be retrieved from a job request initially submitted by the client. This portion of the job request information may also be automatically populated from the profile of the rep or radio station generated in the subscription process. The job request can include such indicators as which radio station(s) is to play the advertisement, etc.

At 1020, broadcast information can also be extracted from the job request, the radio station profile, or other data provided by the client or radio station rep regarding how the advertisement is to be broadcast. The broadcast information can include, for example, such information as the file format, decibel level(s), volume with which the broadcast is to be played, equalization (EQ).

At 1030, the completed advertisement can be uploaded to the automation system at the radio system in readiness for broadcasting.

In an aspect, the various acts presented in methodology 1000 (and other methodologies presented above) can be described as a “Accept-Transfer-Load” process, whereby the submission can be Accepted by the client, the credit amount(s) is Transferred to the individual(s) involved in creating one or more portions of the advertisement content, and the completed advertisement is Loaded into one or more automation systems, to facilitate any of storage of the advertisement, tagging of the advertisement, distribution of the advertisement, broadcasting of the advertisement, etc.

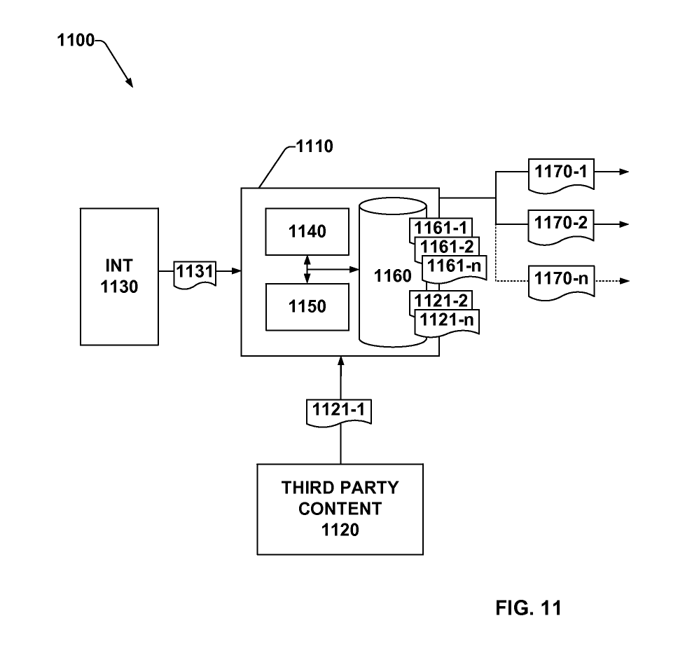

FIG. 11 illustrates an ad generation system 1100, which can be utilized to receive third party content and can incorporate an advertisement into the third party content. The ad generation system 1100 comprises a computer system 1110 to which is connected a third party content component 1120 and an interface component 1130. The third party content component 1120 can be utilized to submit broadcastable content 1121-1 to the computer system 1110. The broadcastable content 1121-1 (and content 1121-2 . . . 1121-n) can be any content that can be pre-recorded and transmittable by a broadcast station, e.g., a radio program, a video program, an audio-visual program. The content of the program may be, for example, a talk show, a podcast, pre-recorded musical content, or a documentary. For example, the broadcastable content can be for transmission over a plurality of radio stations located throughout the USA. Accordingly, a first broadcast radio or television station serving a first region requires a first advertisement to be transmitted as part of the broadcastable content being broadcast in the first region, while a second radio or television station serving a second region requires a second advertisement to be transmitted as part of the broadcastable content being broadcast in the second region.

In an embodiment, the computer system 1110 can be a centralized system such as an ad server. In another embodiment, the third party content component 1120 can be operating on a computing system (not shown) remotely located from the computer system 1110. In a further embodiment, the interface component 1130 can be operating on another computing system (not shown) remotely located from the computer system 1110. In another embodiment, the third party content component 1120 and the interface component 1130 can be located at the computer system 1110. In a further embodiment, the third party content component 1120 and the interface component 1130 can be commonly located in a computer system (not shown) that is remotely located from the computer system 1110.

The computer system 1110 can include a content receiver component 1140, a content selection component 1150, and a storage component 1160. The storage component may, for example, be computer-readable memory component. In an embodiment, the content receiver component 1140 can receive the broadcastable content (e.g., content 1112-1, 1121-2 . . . 1121-n), tag the received broadcastable content with any required identifier(s), timestamp(s), etc., and forward the broadcastable content for storage in the storage component 1160. The storage component 1160 can store the broadcastable content (e.g., content 1112-1, 1121-2 . . . 1121-n), and a plurality of advertisements 1161-1-1161-n (also referred to herein as media content 1161-1-1161-n). As previously mentioned, the plurality of advertisements 1161-1-1161-n can be directed towards, or associated with, different geographic regions, where each geographic region is serviced by a different radio station. Hence, a first advertisement 1161-1 can be configured for transmission by a first radio station transmitting in a first geographic region, while a second advertisement 1161-2 can be configured for transmission by a second radio station transmitting in a second geographic region. Accordingly, a broadcastable content (e.g., broadcastable content 1121-1) can be selected for transmission in both the first geographic region and the second geographic region, whereby the first advertisement 1161-1 is to be incorporated into the broadcastable content 1121-1 for forwarding to the first radio station and the second advertisement 1161-2 is to be incorporated into the broadcastable content 1121-1 for forwarding to the second radio station. While not shown, n-radio stations can be service with n-broadcasts. The term “n” as used herein may be any positive integer, such as, for example, 2 to 50, 5 to 1000, or 25 to 2500.

In an embodiment, the plurality of advertisements 1161-1-1161-n can be an advertisement (e.g., advertisement 110) generated in accordance with one or more embodiments presented in FIGS. 1-10.

The computer system 1110 can further include a selection component 1150 which can be configured to enable selection of any broadcastable content (e.g., content 1112-1, 1121-2 . . . 1121-n) in conjunction with one or more advertisements (e.g., any of advertisements 1261-1-1261-n). The selection component 1150, in an embodiment, can operate in conjunction with the interface component 1130. For example, the interface component 1130 can be utilized to review any broadcastable content (e.g., content 1112-1, 1121-2 . . . 1121-n) stored at the computer system 1110, along with any available stored advertisements (e.g., any of advertisements 1261-1-1261-n). Accordingly, an instruction 1131 can be generated and transmitted from the interface component 1130 identifying the selected broadcastable content and one or more advertisements that are to be incorporated into the broadcastable content.

In response to receiving the instruction(s) 1131, the content selection component 1150 can retrieve the selected broadcastable content and one or more advertisements and combine them to form a broadcast. In accordance with the previous example, the first advertisement 1161-1 can be incorporated into the broadcastable content 1121-1 to form a broadcast 1170-1 for forwarding to the first radio station, and, further, the second advertisement 1161-2 can be incorporated into the broadcastable content 1121-1 to form a broadcast 1170-2 for forwarding to the second radio station. A plurality of broadcasts 1170-1-1170-n can be formed to each be sent to a respective radio station. In an embodiment, each of the plurality of broadcasts 1170-1-1170-n can be automatically forwarded and uploaded to a broadcast automation system located at each respective radio station.

In an embodiment, the interface component 1130 can be configured to query (e.g., via the selection component) to view any information pertaining to the broadcastable content (e.g., content 1112-1, 1121-2 . . . 1121-n) and/or the stored advertisements (e.g., any of advertisements 1261-1-1261-n), as required to enable generation of a desired broadcast 1170-1-1170-n.

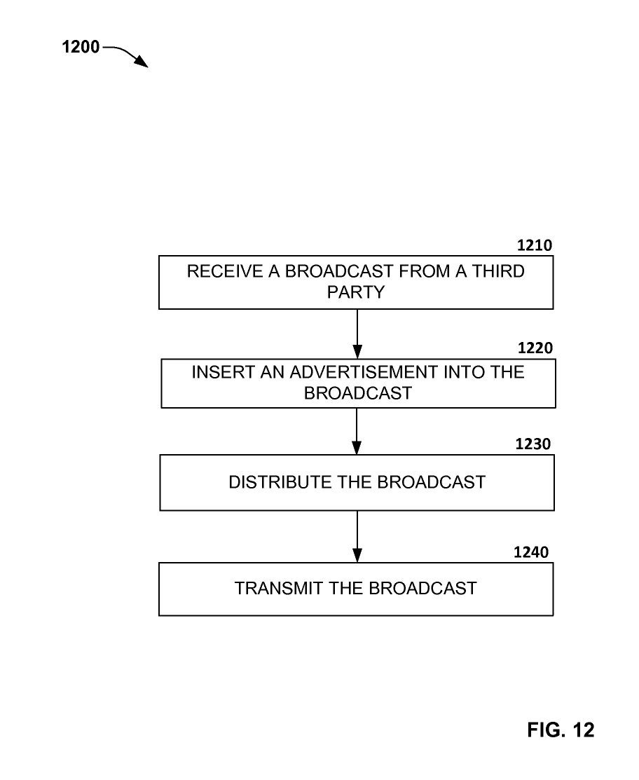

FIG. 12 presents an exemplary methodology 1200 for receiving broadcastable content from a third party and incorporating an advertisement into the third party content. At 1210, broadcastable content is received at a computer system from a third party. The third party content can be content that is to be transmitted, e.g., a radio show, a talk show, that has been pre-recorded. As previously mentioned, the broadcastable content can be for transmission over a plurality of radio stations located throughout the USA. Accordingly, a first radio station serving a first region requires a first advertisement to be transmitted as part of the content being broadcast in the first region, while a second radio station serving a second region requires a second advertisement to be transmitted as part of the content being broadcast in the second region.

At 1220, upon receiving the broadcastable content, the respective advertisement can be incorporated into the broadcastable content. For example, the first advertisement can be incorporated into the content to be broadcast in the first region, while the second advertisement can be incorporated into the content to be broadcast in the second region.

At 1230, the respective broadcastable content (including the respective advertisement incorporated therein) can be distributed to the respective radio stations. In an embodiment, the centralized system can support each of the plurality of radio stations and accordingly, once the respective advertisement has been incorporated into the respective broadcastable content, the computer system can distribute the respective advertisement to the respective radio station.

At 1240, at each of the respective radio stations the received broadcastable content can be incorporated into the transmission schedule of each radio station. In an aspect, a radio station can be utilizing an automation system to schedule radio broadcasts, whereby the automation system automatically inserts the broadcastable content into a schedule for the radio station.

It is to be appreciated that while the various embodiments are presented herein are directed towards generation of broadcastable content which is to be transmitted by one or more radio stations, the various embodiments are not so limited. For example, a third party content is to be broadcast and/or downloaded via the internet and application software, and accordingly, each of the available advertisements can be directed towards one or more geographic regions (e.g., dependent upon where the listener is located, location of a computer or mobile computing device, etc.).

In an embodiment, the content for use in the system and method described in FIGS. 11 and 12, is received from the system and methods described in FIGS. 1-10. For example, the talent pool may provide submissions of full-length programming content that a radio station may wish to use for a time slot in which they have a need for programming. In this case, the content may be purchased through the centralized system and the content may be transmitted, along with advertisements, provided through the systems and methods of FIGS. 11 and 12, and forwarded to the station.

In an embodiment, the full-length programming may include one or more advertisements generated by the content author, e.g. to promote their own products or services, or the advertisements may be for third parties that the author of the content has contracted with.

In an embodiment, a party seeking programming content may provide a job request for such and it will be treated in accordance with the above disclosure. The job request in this case, may additionally include requirements such as, for example, commercial break timing and length, whether additional advertisements are allowed to be added by the author, or the centralized server, and specific content requests (e.g., news, political talk, sports talk, religious messages, or real estate report). Accordingly, advertising content can be selected and added by the author, by the broadcaster, or by the administrator of the content server.

In another embodiment, a broadcast station, such as a radio station, instead of going through commonly used avenues for acquiring musical content, e.g. general licenses provided through ASCAP or BMI, the station may search for and acquire musical content provided from the talent pool, for example, one or more songs. The content, e.g. songs, may be available in the content server, and designated for public broadcast search. Accordingly, the station could search for and acquire musical content for play over the radio waves. The author of the content could set their own price (credit amount) for such submissions, and they would be credited through the system once the content is purchased. Alternatively, the musical content could be provided in response to a job request by a station for a price set by the station. It is contemplated that the aforementioned access logs and unauthorized usage policing methods may also be applicable for this type generally searchable content. The auto-formatting feature described above may also be utilized for directly formatting and loading the content to the stations auto-loading system. In the case that a collaborative effort was used over the system to make the musical content, the above-described method of distributing payments (credits) may also be utilized.

In an embodiment, the credit amount is dependent on a number of broadcasts by the broadcast station. The credit amount may for example, be preset by the submitter, as X number broadcasts, for Y credits, and paid in a lump sum. Alternatively, the credit amount may be a per broadcast credit, that is paid to the submitter each time the broadcast is caused to be loaded from the centralized system to the broadcast stations auto-loading system. In such an embodiment, the centralized system would track and record in memory or receive information from the broadcast station as to the number of broadcasts of each content. In an embodiment, the operator of the centralized system may retain an ownership percentage in each media content that it facilitates a connection from the author to a paying entity. In this case the owner of the centralized system may receive a portion of the credits transferred to the author. This may be set forth in the terms of service upon subscription to the service.

In another embodiment, the broadcast station may also be an entity that broadcasts television over the air or over the Internet or satellite. In another embodiment, the broadcast station may be an entity that publishes hard copies of albums or provides digital downloads or streaming content.

The various components (e.g., the computing device 120, the content server 130, etc.) presented herein can operate in a peer-to-peer manner such that any job request, information, content, requirement, data, submission, etc., can be uniquely tagged and time-stamped such that the computing system can track across the entire system any item associated with one or more job requests or submissions. Hence, any information, such as a client, a sales rep, one or more individuals in a talent pool, a requirement, a client content, a file format, a decibel level, an EQ, a script, a revision, a deadline, a credit amount, an archived file, an indexed file, etc., can all be tracked throughout the system. The system can therefore be utilized as a collaborative content development system with built-in protections for the authors of the content to prevent others from copying or taking their work without authorization (see discussion of FIG. 7 for these protection and policing mechanisms).

In an embodiment, a collaborative module may be presented to submitters from the talent pool. In this module, the submitter may upload content through, e.g., a website interface, and designate the content as private, public, or network. A private designation causes the centralized system to time-stamp the submission only and provide access to the work only to the submitter. A public designation allows the content to be publicly searchable and available to all subscribers of the system, all access events are tracked and recorded. A network designation allows only a selected group of subscribers to search, browse, and have access to the content. The members of the network are designated by the submitter, and may be subscribers that the submitter has previously worked with or has a trusted relationship with.

FIGS. 13-25 are exemplary presentation screens which can be presented to any of a client, a sales representative, one or more individuals in a talent pool, etc., in accordance with one or more embodiments presented herein. The various screens can be presented on a computing device operated by any of a client, a sales rep, or one or more individuals in a talent pool, an administrator of the ad generation system, etc. Accordingly, any of screens 13-25 can be displayed on a local computing device 120, server 130, and one or more computing devices operated locally by one or more individuals in the talent pool 150. While not shown, a login screen can be presented to a respective client, sales rep, individual, etc., to enable entry of a username and password to accordingly access a particular user account and/or user profile.

FIG. 13 presents a user profile screen 1310, whereby the user profile screen 1310 can function as an initial screen from which a user can review all of the job requests (also referred to as production jobs) they have either initiated or have been involved in production of content for, a client can review submissions submitted in response to their job requests, an individual in a talent pool can review a status of one or more job requests for which they generated a submission for, etc.

FIG. 14 presents a job origination screen 1410, whereby the job origination screen 1410 can be presented to a client or a sales rep to facilitate entry of one or more job requests (e.g., a job request 125). In an embodiment, the client can request copywriting and/or audio content for an advertisement to be generated. For the remaining screens presented herein, screens pertaining to selection of an audio content are presented, however it is to be appreciated that similar screens can be presented if the copywriting option had been selected.

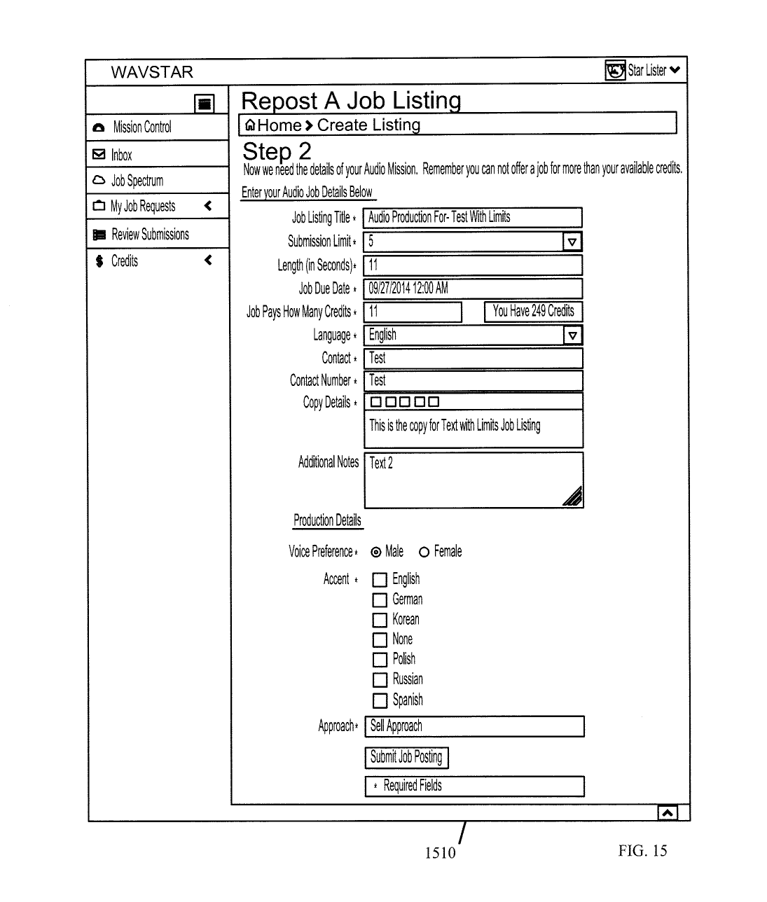

FIG. 15 presents a screen 1510 from which a request for audio content can be generated. A plurality of requirements can be entered pertaining to the desired audio content. As previously described, the requirements can include a length of duration for the audio, a credit amount, a due date, a language, a contact if further information is required, a contact number, details of the copy to be turned into audio, any other notes, a male voice, a female voice, an accent, etc.

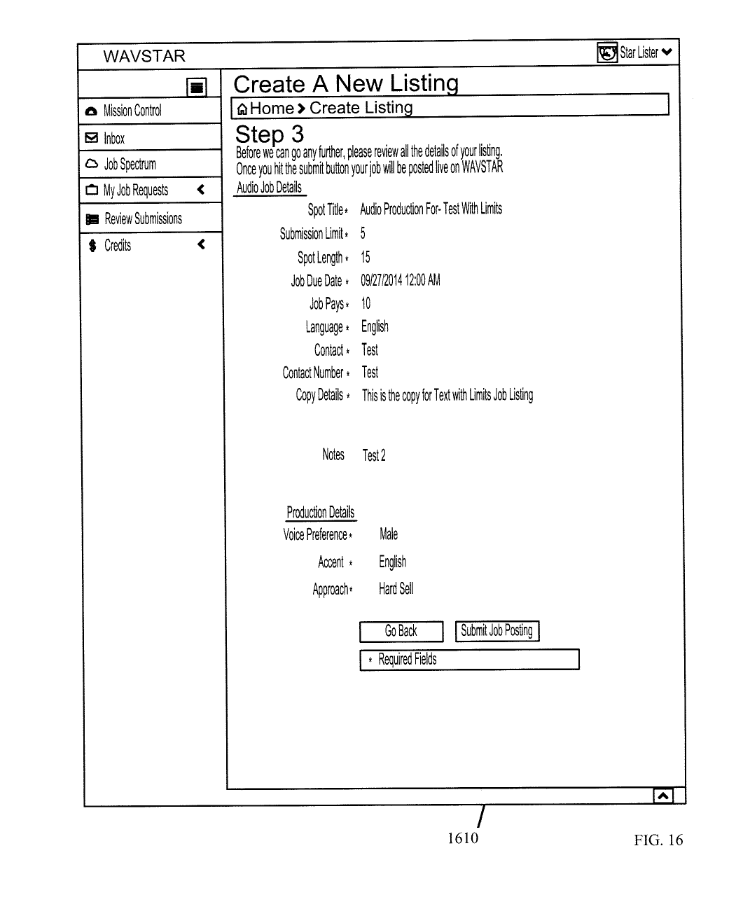

FIG. 16 presents a screen 1610 which provides a review of the information entered in screen 1510. If information has been incorrectly entered on screen 1510 the user can return to screen 1510 to enter the correct information. If the user is satisfied with the entered information, the information can be submitted.

FIG. 17 presents a screen 1710 which provides confirmation of the information entered in the request for audio content.

FIG. 18 presents a screen 1810 which can be presented to the one or more individuals in the talent pool and provides an overview of the jobs requiring content to be submitted.

FIG. 19 presents a screen 1910 which can be utilized by the one or more individuals in the talent pool to submit their audio content.

FIG. 20 presents a screen 2010 which indicates that an audio file was successfully submitted.

FIG. 21 presents a screen 2110 which can be utilized by a client or a sales rep to review each submission presented in response to a job request(s).

FIG. 22 presents a screen 2210 which can be utilized by a client or a sales rep to rate or review a submission provided by the one or more individuals in the talent pool.

FIG. 23 presents a screen 2310 which can be utilized by a client or a sales rep to confirm selection of a submission provided by the one or more individuals in the talent pool.

FIG. 24 presents a screen 2410 which can be utilized by a client or a sales rep to either initiate production of an advertisement with the selected audio content and/or forward the audio content to a colleague.

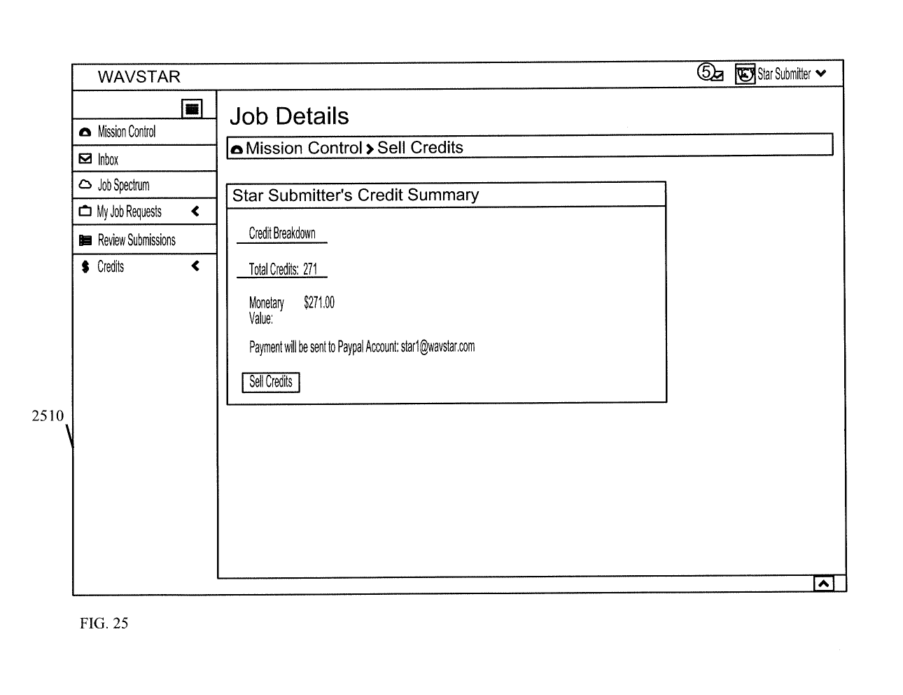

FIG. 25 presents a screen 2510 which can be utilized by an individual in the talent pool to exchange their credit amount(s) for a monetary value or a goods and/or service.

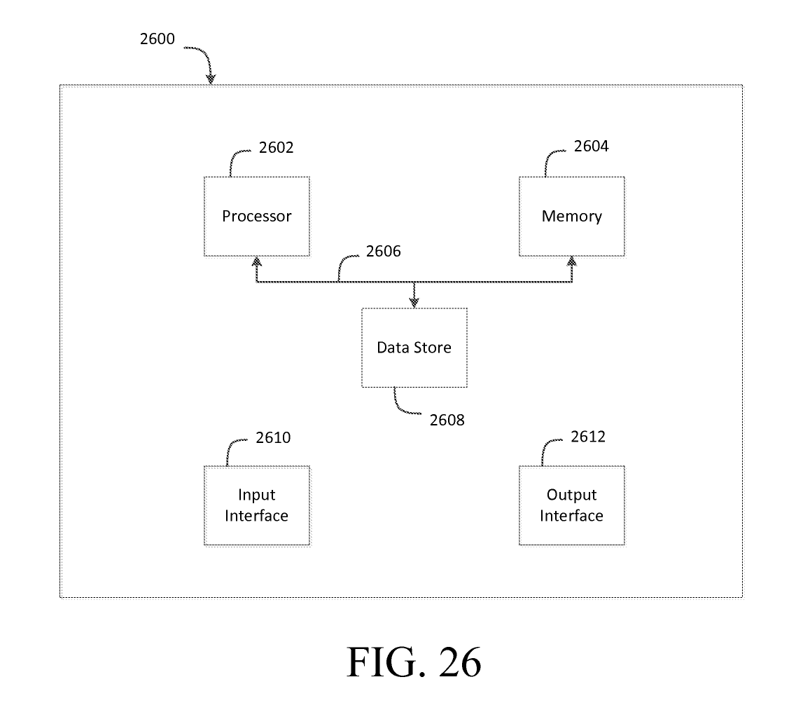

Referring now to FIG. 26, a high-level illustration of an exemplary computing device 2600 that can be used in accordance with the systems and methodologies disclosed herein is illustrated. For instance, the computing device 2600 may be used in a system to facilitate receipt of a job request and according receipt of one or more submissions generated in accordance with the job request. The computing device 2600 includes at least one processor 2602 that executes instructions that are stored in a memory 2604. The instructions may be, for instance, instructions for implementing functionality described as being carried out by one or more components discussed above or instructions for implementing one or more of the methods described above. The processor 2602 may access the memory 2604 by way of a system bus 2606. In addition to storing executable instructions, the memory 2604 may also store operating parameters, required operating parameters, and so forth.

The computing device 2600 additionally includes a data store 2608 that is accessible by the processor 2602 by way of the system bus 2606. The data store 2608 may include executable instructions, operating parameters, required operating parameters, etc. The computing device 2600 also includes an input interface 2610 that allows external devices to communicate with the computing device 2600. For instance, the input interface 2610 may be used to receive instructions from an external computer device, from a user, etc. The computing device 2600 also includes an output interface 2612 that interfaces the computing device 2600 with one or more external devices. For example, the computing device 2600 may display text, images, etc. by way of the output interface 2612.

Additionally, while illustrated as a single system, it is to be understood that the computing device 2600 may be a distributed system. Thus, for instance, several devices may be in communication by way of a network connection and may collectively perform tasks described as being performed by the computing device 2600.

As used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices.

Various functions described herein can be implemented in hardware, software, or any combination thereof. If implemented in software, the functions can be stored on or transmitted over as one or more instructions or code on a computer-readable medium. Computer-readable media includes computer-readable storage media. A computer-readable storage media can be any available storage media that can be accessed by a computer. By way of example, and not limitation, such computer-readable storage media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and blu-ray disc (BD), where disks usually reproduce data magnetically and discs usually reproduce data optically with lasers. Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of communication medium. Combinations of the above should also be included within the scope of computer-readable media.

The term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B.

Further, as used herein, the term “exemplary” is intended to mean “serving as an illustration or example of something”.

The articles “a”, “an”, and “the” should be interpreted to mean “one or more” unless the context clearly indicates the contrary.

What has been described above includes examples of one or more embodiments. It is, of course, not possible to describe every conceivable modification and alteration of the above structures or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the details description or the claims, such term is intended to be inclusive in a manner similar to the term “comprising” as “comprising” is interpreted when employed as a transitional word in a claim.

What is claimed is:

1. A computer system, comprising:
a processor, executing instructions stored in a memory, the instructions comprising components including:
a memory component, the memory component configured to store a third party content and a first media content;
a content selection component, wherein the content selection component is configured to:
retrieve the third party content from the memory component;
retrieve the first media content from the memory component;
generate a first broadcast, wherein the broadcast generation includes combining the third party content with the first media content; and
forward the first broadcast to a first broadcast station.

2. The computer system of claim 1, further comprising a content receiver component, wherein the content receiver component is configured to:
receive the third party content over the Internet from a third party content component remotely located from the computer system; and
store the third party content in the memory component.

3. The computer system of claim 1, wherein the content selection component is further configured to:
receive an instruction from a remotely located interface component, wherein the instruction identifies the third party content to be combined with the first media content.

4. The computer system of claim 1, wherein the memory component is further configured to store a plurality of media content, the plurality of media content includes the first media content, the plurality of media content are available for incorporation into the third party content.

5. The computer system of claim 4, wherein the plurality of media content also include a second media content available for incorporation into the third party content, wherein the second media content is for transmission by a second broadcast station.

6. The computer system of claim 5, wherein the first broadcast station is transmitting in a first geographic region and the second broadcast station is transmitting in a second geographic region.

7. The computer system of claim 1, wherein the third party content is one of a pre-recorded radio show, a pre-recorded talk show, a pre-recorded podcast, pre-recorded musical content, or a pre-recorded documentary.

8. The computer system of claim 1, wherein the content selection component is further configured to receive a query from a remotely located interface, wherein the query requests information relating to at least one of the third party content or the first media content.

9. A method comprising:
receiving third party content;
receiving a first instruction, wherein the instruction indicating the third party content is to be combined with a first media content to form a first broadcast;
retrieving the first media content from a memory component;
combining the third party content with the first media content; and
forwarding the first broadcast to a first radio station.

10. The method of claim 9, further comprising:
receiving a second instruction, the second instruction indicating the third party content is to be combined with a second media content to form a second broadcast;
retrieving the second media content from the memory component;
combining the third party content with the second media content; and
forwarding the second broadcast to a second radio station.

11. The method of claim 10, wherein the first radio station is configured to transmit content at a first geographic region and the second radio station is configured to transmit content at a second geographic region.

12. The method of claim 9, wherein the third party content is one of a pre-recorded radio show, a pre-recorded talk show, a pre-recorded podcast, pre-recorded musical content, or a pre-recorded documentary.

13. The method of claim 10, further comprising receiving a query, the query requesting information relating to the first media content and at least one other media content stored in the memory component; transmitting the query results to a computing device of a broadcast station and formatting the first media content and the at least one other media content for broadcast.

14. A computing system comprising a memory that includes instructions that, when executed by a processor of the computing system, cause the processor to perform acts comprising:
receiving a plurality of audio, audio-visual, or visual content from a plurality of submitter computing devices;
storing the audio, audio-visual, or visual content in memory;
transmitting content results to a computing device in response to:
(a) a job request, wherein the audio, audio-visual, or visual content meets content requirements of the job request; or
(b) a search query, the search query requesting information relating to the audio, audio-visual, or visual content meets content;
receiving an indication for purchase of one or more content results;
crediting an account associated with an author of the purchased content with a credit amount associated and stored in memory with the purchased audio, audio-visual, or visual content;
forwarding the first broadcast to a first broadcast station.

15. The computing system of claim 14, the acts further comprising:
recording the time when the audio, audio-visual, or visual content was received or stored in memory;
storing in memory access information that comprises identifying information associated with each access of the audio, audio-visual, or visual content; and
receiving a request for the access information from the submitter computing device that is associated with the audio, audio-visual, or visual content;
transmitting the access information to the submitter computing device.

16. The computing system of claim 14, wherein the broadcast station is a radio station.

17. The computing system of claim 14, wherein the audio, audio-visual, or visual content is one of a pre-recorded radio show, a pre-recorded talk show, a pre-recorded podcast, pre-recorded musical content, or a pre-recorded documentary.

18. The computing system of claim 14, wherein the credit amount is dependent on a number of broadcasts by the broadcast station, and the acts further comprise recording a number of broadcasts of the purchased content.

19. The computing system of claim 14, wherein the purchased audio, audio-visual, or visual content is a collaborative effort resulting from submissions from first and second submitter computing devices, and the acts further comprise: crediting accounts of both the first and the second computing device.

20. The computing system of claim 14, wherein the acts further comprise: receiving a request for combining the purchased audio, audio-visual, or visual content with a second audio, audio-visual, or visual content, wherein the purchased audio, audio-visual, or visual content is a full-length broadcast program and the second audio, audio-visual, or visual content is an advertisement.
